(19) United States
(12) Patent Application Publication
(10) Pub. No.: US 2008/0008625 A1
(43) Pub. Date: Jan. 10, 2008

(54) Infrared sensor

(76) Inventors: Ross C. Thomas, Boulder, CO (US); Michael T. Carter, Denver, CO (US); Joseph Anthony Trimboli, Boulder, CO (US)

Correspondence Address: GREENLEE WINNER AND SULLIVAN P C, 4875 PEARL EAST CIRCLE, SUITE 200, BOULDER, CO, 80301, US

(21) Appl. No.: 11/259,948

(22) Filed: Oct. 27, 2005

Related U.S. Application Data
(60) Provisional application No. 60/622,873, filed on Oct. 27, 2004.

(51) Int. Cl. G01N 21/00

(52) U.S. Cl. 422/82.05; 422/91

(57) ABSTRACT

Devices, materials and methods for the detection of one or more target analytes, particularly volatile organic compounds (VOCs) in air or other gases. Point sensors and sensor arrays for the detection of one or more of such analytes in air or other gases. Sensors employ the detection of IR absorption of wavelengths characteristic of a target analyte or a class of target analytes to detect the presence of and/or measure the concentration of one or more target analytes in air or other gases. Sensors employ sorbent layers into which one or more of the target analytes are adsorbed from the air or other gases to be analyzed. Preferred sorbent layers comprise polymer sorbents, metal oxide sorbents or mixtures thereof.

### CROSS-REFERENCE TO RELATED APPLICATIONS

This application claims priority to U.S. provisional application Ser. No. 60/622,873, filed Oct. 27, 2004, which is incorporated by reference in its entirety herein.

### STATEMENT REGARDING U.S. GOVERNMENT FUNDING

This invention was made under funding from the United States Government through the U.S. Marine Corp System Command under SBIR contract nos. M67854-02-C-3087 and M67854-04-C-3104 and the U.S. Army CECOM Night Vision and Electronic Sensors Directorate under SBIR contract no. DAAB07-01-C-L852. The United States government has certain rights in this invention.

### BACKGROUND OF THE INVENTION

Over the past several years, a considerable effort has been spent developing new and improved chemical sensors for detecting the presence of chemical warfare agents (CWAs) and explosive related chemicals (ERCs). This invention relates to methods, devices and materials useful for infrared (IR) detection of organic species, particularly volatile organic compound (VOCs) and more particularly CWAs and ERCs. More specifically, the invention relates to IR sensors that can be employed as point sensors for the detection of VOCs and sensor arrays and systems containing such point sensors. These sensors are based on the ability to detect and quantitatively measure IR absorption by the target species and further to correlate such measurements with the concentration of the target species in the sensor environment. Sensors of this invention can be employed, for example, to reliably detect the presence of various hazardous materials.

A chemical sensor is a device that integrates a physical transduction platform with a chemically sensitive interface.¹ Sensors are extensively used in applications where a quantitative measurement of a chemical species is required, but where specific limitations such as the cost and/or limited access prevent using a conventional analytical instrument.¹⁻³ Chemical sensors are increasingly applied for environmental cleanup and monitoring, industrial process control, and industrial emissions monitoring. The use of chemical sensors has increased substantially because of their improved sensitivity, small size, ruggedness, and low power consumption.¹⁻⁴ Preferred chemical sensors are readily configured for desired analyte(s), are small and lightweight, selective, sensitive, and stable, have low power requirements and have fast response times.

Numerous reports describe the use of polymer thin films integrated with electronic, acoustic wave, electrochemical, thermal and certain types of optical physical platforms to detect a wide range of organic and inorganic analytes.¹⁻⁴ In such sensors, the analyte(s) of interest are adsorbed from the surrounding environment (e.g., the air) into the polymer sorbent and effect a change in a measurable property of the film (e.g., size, weight, acoustic wave frequency.) One of the main limitations with most such chemical sensors is their lack of selectivity for specific analytes, because, for the most part, they rely upon indirect measurement methods.

Chemical sensors, particularly for detection of analytes in gases, have been constructed from metal oxide materials.⁵⁻⁸ These sensors are based upon a change in conductance of the metal oxide on interaction with adsorbed materials. Most often, these devices consist of a polycrystalline powder located on some kind of support. Physical properties of the oxide, such as grain boundary size, pore structure, and stoichiometry, determine the conductance of the material. When particular gases are introduced over the oxide, its conductance can change due, for example, due to reactions with surface oxygen species that cause charge injection or through changes in lattice oxygen defects.

Adsorption of various species onto metal oxides has been studied, for example, in the development of catalysts and semi-conducting metal oxide (SMO) sensors. With respect to CWA, certain metal oxides have been shown to strongly bind organic compounds, such as the nerve-agent simulant dimethyl methyl phosphonate (DMMP) and in some cases to cause its decomposition.⁹⁻¹²

Kim et al.⁹ reports the results of the use of thin film infrared techniques to study absorption of certain organophosphorous compounds (DMMP, dimethyl hydrogen phosphonate (DMHP) and trimethy methyl phosphonate (TMP)) on TiO₂ and WO₃. The purpose of the experiments was to understand the surface chemistry that occurs on thin film chemiresistive SMO sensors during operation and correlate the species observed with sensor function. Transmission spectra were reported collected from thin layers of TiO₂ or WO₃ supported on a CsI window which had been exposed to the organophosphorous compounds. The thin layers were exposed to these species at full vapor pressure at room temperature for 5 minutes followed by evacuation. The data are reported to indicate that certain organophosphorous compounds undergo decomposition on the metal oxide surfaces at temperatures above 200° C. which lead to decreased sensor performance. A similar study Kanan and Tripp¹⁹ reported the results of studies of adsorption of DMMP, TMP, methyl dichlorophosphate (MDCP) and triclhorophosphate (TCP) on silica. It is reported that silica can be used to selectively adsorb DMMP from a gas stream containing methanol/DMMP mixtures. It is suggested that silica can be employed in prefiltering/preconcentration strategies for semiconductive metal oxide based sensing devices.

Tesfai et al.¹¹ reports infrared diffuse reflectance studies of the decomposition of DMMP on alumina-supported iron oxide employing Fourier transform infrared (FT-IR) methods. Spectra were acquired on exposure of α-alumina and α-alumina-supported iron oxide to a flowing dilute mixture of DMMP in helium (1:1000) at about 500 mTorr. DMMP is reported to adsorb molecularly on α-alumina, but to adsorb on the supported iron oxide with cleavage of the P—C bond resulting in adsorption of a fragment. Earlier studies by this same group (Mitchell et al.¹²) examined the adsorption of DMMP on aluminum oxide, magnesium oxide, lanthanum oxide, and iron oxide surfaces. Aluminum, magnesium, and lanthanum oxides were reported to behave similarly with initial binding of the P═O species to the surface at an acid site, followed by stepwise elimination of the methoxy groups, as the temperature was raised above 50° C. Iron oxide was also reported to cleave the P—C bond of DMMP.

Rusu et al.¹⁰ have employed FT-IR to study adsorption and decomposition of DMMP on TiO₂ as a function of temperature. At temperatures above 214 K hydrolysis of DMMP on TiO₂ is reported. The TiO₂ powder was pressed into a tungsten grid in an IR cell and the TiO₂ sample was exposed to DMMP introduced into the cell.

Spectroscopic studies such as those noted above typically focus on brief exposures of the sorbent at high concentrations of analyte (unlikely to be encountered in sensing applications) followed by evacuation of the analyte. The sensors of this invention, in contrast, are intended for detection and measurement of relatively low concentrations of analyte (>1000 ppm) in gas (such as air).

While a number of conductometric oxide-based sensors have been described several limitations exist. The conductance of a metal oxide sensor at room temperature is too low to be measured with inexpensive instrumentation, and so these devices must often be heated to 300° C.-600° C. to make a measurement. In addition, the selectivity of these sensors is poor because any gaseous species that can react with surface or lattice oxygen can alter the conductance.¹³ These sensors also rely upon indirect measurements rather than direct measurement of a property of the target analyte.

Thus, there is a need in the art for chemical sensors which can operate at ambient temperatures, do not require heating to high temperatures (e.g., 300° C. or more) and which exhibit improved selectively for a given target analyte.

Many organic and inorganic analytes exhibit infrared absorption at one or more wavelengths that are characteristic of their structure. Measurement of infrared absorption wavelengths can thus provide a highly selective detection method for infrared active molecules. Chemical sensors based on infrared absorption at one or more characteristic wavelengths of an infrared active molecule would provide the analyte selectivity that is lacking in many current chemical sensors. Reliable detection of infrared active analytes at trace concentrations in air, however, currently requires a sample pathlength ranging between 1 m to 10 m. The present invention provides chemical sensor configurations employing IR absorption measurements of target analytes adsorbed into sorbent layers for reliable trace analyte detection and the determination of analyte concentration.

Methods have been reported for studying adsorption of chemical species employing transmission IR spectroscopy (Mawhinney et al.)¹⁴ Powdered adsorbents are compressed into a tungsten grid. Adsorbents may be diluted with IR-transparent KBr powder and compressed into the grid. The reference exemplifies studies on carbon, resin (XE-555) and alumina powders diluted to 4-15% by mixing with KBr. More details of the method and descriptions of a sample grid containing an array of pressed samples are provided in Basu et al.¹⁵ and Ballinger et al.¹⁶ See also Rusu et al.¹¹. A thin film technique in transmission infrared spectroscopy has been reported to study chemisorbed species on silica Tripp and Hair¹⁷ and Morrow et al.¹⁸ See also Kim et al.⁹

Adsorbent materials such as polymers and metal oxides have been employed in the detection of various analytes, for example, to preconcentrate an analyte from an environment for later desorption for detection. Sorbents have also been employed as chemically sensitive film or coatings in chemical sensors. In these sensors, a property of the adsorbent material or film (or of a non-analyte component of the film, e.g., a dye) is affected by adsorption of an analyte and changes in that property are used to detect the presence of the analyte. In such chemical sensors, the presence of the analyte is measured indirectly through its effect on the adsorbent. For example, adsorption of an analyte can increase the weight of a sorbent layer or film, cause the layer of film to swell or change the resistance of the layer or film. Additionally, an analyte may change the refractive index of the layer of film or effect a change of fluorescence intensity or wavelength of a dye carried in the layer of film. In contrast, the chemical sensors of this invention are based on direct measurement of IR-absorption of the analyte in the sorbent layer or film.

U.S. Pat. No. 6,455,003 relates to a preconcentrator for chemical detection which employs a preconcentrator tube containing a sorbent material. Fluid is passed through the sorbent material where some chemicals accumulate. Accumulated chemicals are pumped to a detector. Exemplified sorbents are Tenax® TA (a porous polymer comprising 2,6 diphenyl-p-phenylene oxide), Tenax® GA, Carbosieve and granulated charcoal. The preconcentrator is separated from the detector and adsorbed material concentrated in the sorbent element must be pumped into the detector to be detected. The exemplified detector is a surface acoustic wave detector.

U.S. Pat. No. 5,482,678 relates to a chemical sensor which is based on the use of a material which swells and expands on exposure to an organic analyte. Stresses generated on expansion are detected to provide sensing of the analyte. Swellable polymer such as RTV silicone polymer, synthetic rubber, polyvinyl chloride, polymethyl methacrylate, silicone, or a mixture of these cross-linked polymers which expand in the presence of an organic chemical are employed in the sensor.

U.S. Pat. No. 5,910,286 relates to a chemical sensor comprising an acoustic wave transducer and a sensitive layer of a macroporous crosslinked material which is called a “molecular fingerprint” material. This material is described as being formed by polymerization and cross-linking in the presence of molecular or ionic species which serves as a “gauge” to form cavities “whose steric and functional configuration” facilitates binding of species similar to the gauge molecule or ionic species.

U.S. Pat. No. 6,357,278 relates to a sensor which comprises a substrate and a polymeric film disposed on the substrate. The polymeric film is described as comprising at least one hardblock component and at least one softblock component. Thermoplastic elastomers are exemplified. The polymeric film is said to enhance detection of target compounds not normally sensed by a sensor without the polymeric film. The polymeric film is described as “disposed as a polymeric film coating on a surface of a sensor's piezoelectric crystal.” Sensors with which the invention can be employed are described as “any appropriate sensor and sensor substrate, such as, but not limited to, acoustic wave sensors that include, but are not limited to, quartz crystal microbalance (QCM) sensors, and surface acoustic wave (SAW) chemical sensors.” U.S. Pat. Nos. 5,595,586 and 5,391,300 are described as providing examples of hardblock and softblock polymers. U.S. Pat. No. 5,595,586 is described as teaching a method to sorb and desorb volatile organic compounds (VOCs), such as trichloroethylene (TCE), from air using softblock and hardblock polymers, such as such as a polyester elastomer or carbon filled rubber.

U.S. Pat. No. 6,500,547 relates to a sensor assembly for detection of a target material in an environment in which an amorphous fluoropolymer material coating is provided on a surface of the sensor. The polymer coating is reported to undergo changes in response to interaction with the target material and that those changes can be related to the concentration of the target material. The polymer property that may undergo such changes can be mass, visco-elastic properties or other mechanical properties, dielectric or optical properties, such as absorbance, scattering, refractive index or luminescence. Additionally, a dye can be incorporated into the polymer and it is reported that changes in an optical property of the dye on interaction with the target material can be correlated with target concentration. The sensor detects the change in property of the polymer or that of a dye in the polymer on interaction with the target material, but does not directly detect or measure a property of the target material itself.

U.S. Pat. No. 6,290,911 relates to arrays of chemically-sensitive polymer-based sensors. The sensors are described as based on a polymeric organic material that is capable of absorbing a chemical analyte on contact, where absorbance of the analyte causes the polymeric material to swell generating a response that can be detected. The arrays contain a number of discrete chemically varying sensor films which are blends of two or more organic materials. Different blends of polymers are said to exhibit varying abilities to absorb different analytes and as a result that arrays of compositionally distinct sensors will give different responses to different analytes. U.S. Pat. Nos. 6,387,329 and 6,759,010 relate to chemical sensor arrays wherein a sensor functions by generation of a change in resistance of a material on contact with an analyte. Sensors of the array can be polymers which sorb analytes.

U.S. Pat. No. 6,521,185 relates to detection of an analyte using a fluorescent probe which includes a polymer matrix and a dye immobilized in the matrix. The polymer matrix has an affinity for the analyte of interest and the dye is sensitivity to the analyte when excited by an excitation source when immobilized in the matrix. Specific dyes and polymers are described for detection of certain analytes. U.S. Pat. No. 6,300,638 relates to a device for detecting analytes employing total internal reflection fluorescence spectroscopy comprising a probe which contains a thin sorbent polymer coating containing a fluorophore. The analyte is reported to be detected by monitoring a change in fluorescence on contact of the probe with the analyte. Organic thin films having affinity for agent vapors and the immobilization of fluorescent probes in these thin films are reported. The use of near-infrared fluorophores and semiconductor diode laser excitation are described. Fluoropolyol (FP), poly(epichlorohydrin) (PECH), and Nafion films deposited on beveled glass substrates are examples of probe materials employed. Published U.S. patent application 2002/0192836 (published Dec. 19, 2002) relates to the use of similar fluorescent probes for the detection of chemicals, particularly chemical warfare agents. Certain combinations of polymer and fluorophore are described for detection of mustard and soman. Published U.S. application 2002/0076822 also relates to a fluorescence-based detection of basic gases, such as DMMP, in which changes in fluorescence of a solvatochromic dye on interaction with the basic gas is monitored. The dye is isolated in a certain polymer matrix which is contacted with the basic gas.

### SUMMARY OF THE INVENTION

The invention provides devices, materials and methods for the detection of one or more target analytes, particularly volatile organic compounds (VOCs) in air or other gases. The invention more specifically provides point sensors for the detection of one or more of such analytes in air or other gases. The devices of this invention employ the detection of IR absorption of wavelengths characteristic of a target analyte or a class of target analytes to detect the presence of and/or measure the concentration of one or more target analytes in air or other gases. The devices of this invention employ sorbent layers into which one or more of the target analytes are adsorbed from the air or other gases to be analyzed. In one embodiment, the sorbent layers are polymer sorbent layers. In another embodiment, the sorbent layers are metal oxide sorbent layers. In yet another embodiment, the sorbent layers comprise a mixture of polymer and metal oxide. The one or more target analytes are concentrated in the sorbent layer and detected therein employing IR absorption measurements. Preferred sorbent layers comprise polymer sorbents, metal oxide sorbents or mixtures thereof.

Various polymer materials are known in the art which adsorb volatile organic species. In particular, polymer materials that have been developed for use in surface acoustic wave detection methods which exhibit such sorbent properties are useful in the devices of this invention. Various metal oxides are known in the art which adsorb volatile organic species. In particular, metal oxides that have been developed for use in chemical sensors which exhibit such sorbent properties are useful in the devices of this invention. The analyte may be adsorbed in or to the sorbent layer non-dissociatively or dissociatively (e.g., where one or more chemical bonds in the analyte are broken or modified on adsorption). The mode of adsorption is not critical as long as the adsorbed analyte retains structure which exhibits IR absorption that is associable to the analyte (or a class of related analytes).

Preferred sensors of the invention are selective for a given target analyte or more than one target analyte, are stable and sensitive to detection of the target analyte, as well as easily configured for detection of one or more of such target analytes. Preferred sensors for a given target analyte or class of target analytes exhibit selectivity for detection of the analyte or class of analytes in the presence of potentially interfering chemical species. Preferred sensors are small and lightweight for use in portable applications, but which exhibit enhanced sensitivity, rapid response time and lower detection limits compared to currently available chemical sensors.

Sensors of this invention provide for detection of and/or determination of the concentration of one or more target analytes in air or other gases. The sensors are particularly useful for the detection of CWAs, such as organophosphorous CWA, the detection of chlorinated species and/or the detection of nitro aromatic compounds and other nitro compounds that may be components of explosive materials.

Volatile organic species that can be detected using the methods herein are infrared active exhibiting an infrared absorption spectrum on irradiation with IR light.

The invention provides chemical sensors for detection of one or more infrared active analytes in a gas in contact with the sensor which comprises an infrared source, one or more sorbent layers which may each be supported on an infrared transparent substrate; and an infrared detector. Sorbent layers, particularly those formed from metal oxides, can be formed as self-supporting elements (e.g., pressed thin pellets) which are mounted into the sensor or pressed into a supporting holder or frame. The sorbent layer(s) of the sensor are in contact with the gas to be analyzed such that one or more volatile analytes in the gas are adsorbed into the sorbent polymer layer. The infrared light emitted from the infrared source passes through the one or more sorbent layers and is thereafter detected in the infrared detector to measure IR absorption at one or more selected wavelengths by the adsorbed analyte. The one or more sorbent layers are aligned along the optical path of light passing through the sensor. When two or more sorbent layers are employed the layers are arranged in series along the optical path of the sensor such that light passes successively through each layer. In a preferred embodiment, the sensor comprises two or more sorbent layers (any of which may have the same or different sorbent materials) aligned in series along the optical path of the sensor.

A sensor may also contain parallel arrangements of two or more sorbent layers or two or more series of sorbent layers wherein light from two or more sources (or spatially separated light from a single light source) is separated directed into the parallel sorbent layers or series of parallel layers.

Any IR source of appropriate size and power requirements can be employed. In a specific embodiment, the IR source is a broad band IR source, for example, a solid state IR emitter. Any IR detector of appropriate size and power requirements can be employed. The detector is sensitive to changes in IR intensity as a function of selected wavelengths. The detector can, for example, be configured to detect changes in IR intensity at one or more wavelengths in the IR spectral region. In a specific embodiment, the IR detector is a multispectral detector, for example, an IR detector which combines one or more selected band pass filters with a pyroelectric detector. More specifically, the IR detector is configured to detect IR absorbance at two or more wavelengths, one of which is a reference wavelength where absorbance of any target analyte is insignificant. The IR detector can be configured, for example, to detect absorbance at one or more wavelengths characteristic of a given target analyte (or class of target analytes). The IR detector can be configured to detect IR absorbance at one or more wavelengths characteristic of each of one or more target analytes. IR absorbance at a wavelength characteristic of a target analyte adsorbed in a sorbent layer is found to be proportional to the concentration of that analyte in the sorbent layer. Preferred detectors operate at ambient temperatures and do not require cooling to temperatures below 0° C. One exemplary useful detector is a deuterated triglycine sulfate-based (DTGS) detector. In a specific embodiment, the detector is not a cryogenic detector.

In a specific embodiment the IR detector is configured to monitor IR absorption at multiple wavelengths as well as to monitor the ratio of IR absorbance between two or more wavelengths. More specifically, the IR detector is configured to monitor the ratio (Aₜ/Aᵣ) of IR absorbance at one or more wavelengths characteristic of the target analyte (Aₜ) to IR absorbance at a reference wavelength (Aᵣ). One or more than one of such ratios of each target analytes may be monitored. Monitoring of such ratios provided more accurate detection and minimizes the probability of false alarms where the target analyte is incorrectly indicated to be present.

The one or more sorbent layers of the sensor function to adsorb and as a result to concentrate one or more target analytes from air or any other gas in contact with the sorbent layer. The presence and/or concentration of the one or more target analytes, e.g. target VOCs, in the gas or air is then detected or determined using IR absorption measurements.

In a specific embodiment, sensors of this invention comprise two or more sorbent layers, particularly polymer sorbent layers or metal oxide sorbent layers. It has been found that the use of multiple thinner layers of sorbent provides for significant improvement in sensor response time compared to the use of one or a few thicker layers of the same sorbent. Sorbent layers can range in thickness generally from about 0.1 microns to 1000 microns thick. Self-supporting layers of metal oxide may range from 1 mm up to 10 mm thick. The sorbent layer is, however, preferably equal to or less than 100 microns thick. More preferably, the sorbent layers are equal to or less than about 20 microns thick. Preferred thickness ranges of the sorbent layers are 0.1 to 20 microns, 0.2 to 20 microns, 0.5 to 10 microns, and 1 to 5 micron.

In a specific embodiment, the polymer sorbent is a fluorinated epoxy (FE). FE sorbent layers are formed, for example, by spin coating substrates using solutions of 1-15% by weight FE in 1-butanol, isopropanol and/or other volatile alcohols. FE sorbent layers are particularly useful in applications for the detection of CWAs, particularly organophosphorous compounds.

In another specific embodiment, the polymer sorbent is a polyolefin and more particularly is a polyisobutylene (PIB). PIB sorbent layers are formed, for example, by spin coating substrates using solutions of 0.5-10 weight percent PIB in toluene. PIB sorbent layers are particularly useful in applications for the general detection of VOCs, particularly chlorinated hydrocarbons and more particularly tetrachloroethylene.

In another specific embodiment, the polymer sorbent layer is a poly(vinylchloride-co-vinylacetate-co-vinylalcohol) mixed with diethyleneglycol adipate (DEGA) plasticizer. Sorbent layers of this material are formed, for example, by spin coating substrates using solutions of poly(vinylchloride-co-vinylacetate-co-vinylalcohol) 10 to 50 mg/mL in tetrahydrofuran, mixed with diethyleneglycol adipate (DEGA) plasticizer to obtain final DEGA weight percentage in the range 20% to 80%. In a preferred embodiment, sorbent layers were formed using 30 mg/mL PVCAA in tetrahydrofuran mixed with DEGA to obtain final DEGA weight percentage of 50-80%.

In another specific embodiment, the sorbent is a metal oxide, for example, a metal oxide of a transition metal, a lanthanide metal, a Group 3B or 4B metal, or an alkaline earth metal and in particular is a metal oxide selected from the group consisting of oxides of Ti, Zn, Ce, Sn, Fe, Al, Si, Ga, La, Nb, Pb, Mg, Zr, W, V, Cr, Ni, Cu, Y, Sr, Co and mixtures thereof. In preferred embodiments, the metal oxide is TiO₂ which may be in the anatase, rutile or amorphous form. In a more preferred embodiment, the metal oxide sorbent is in an amorphous form. Specifically amorphous TiO₂ is a preferred sorbent. Other preferred metal oxides are ZnO and CeO₂. More specifically, amorphous TiO₂ is particularly useful as a sorbent for detection of organophosphorous compounds such as DMMP. A sorbent layer may comprise two or more different metal oxides. A sorbent layer may comprise one or more metal oxides in combination with one or more metals, including one or more of Pt, PD, Au, Cu, Ru, Ni, Ag, Fe, Cr, or Os. A sorbent layer may comprise up to about 10% by weight of a metal. Sorbent layers having 0.01 to 10% by weight of a metal, those having 0.1 to 5% by weight of a metal, and those having 0.01 to 1% by weight of a metal can be employed in the sensors of this invention.

In another specific embodiment, the sorbent comprises a metal oxide and a polymer. Such sorbents can preferably contain from about 10% by weight metal oxide to 90% by weight metal oxide and more preferably contain about 25% to about 75% by weight of metal oxide. Such sorbents preferably can contain from about 10% by weight polymer to about 90% by weight polymer and more preferably contain 25% to about 75% by weight of polymer. Additionally sorbent layers may contain a metal as noted above, preferably in an amount ranging from 0.01% by weight to 10% weight.

Chemical sensors of this invention can be configured by choice of sorbent (or sorbents) and IR wavelengths that are monitored or detected for detection of one or more target analytes, particularly VOCs. The chemical sensor can be configured to detect or monitor the concentration of one or more CWAs. The chemical sensor can be configured to detect or monitor the concentration of one or more organophosphorous compounds. The chemical sensor can be configured to detect or monitor the concentration of one or more ERCs. The chemical sensor can be configured to detect or monitor the concentration of one or more nitroaromatic compounds. The chemical sensor can be configured to detect or monitor the concentration of one or more chlorinated hydrocarbons. The chemical sensor can be configured to detect or monitor the concentration of perchloroethylene.

The invention includes chemical sensor wherein the sorbent polymer layers are each between 0.5 microns and 10 microns thick. The invention includes chemical sensors wherein the sorbent polymer layers are each between 0.1 microns and 5 microns thick. The invention includes chemical sensor wherein the sorbent metal oxide layers are each between 0.5 microns and 10 microns thick. The invention includes chemical sensors wherein the sorbent metal oxide layers are each between 0.1 microns and 5 microns thick.

A chemical sensor of this invention can be configured by choice of sorbent and IR wavelengths that are being detected or monitored to detect two or more target analytes. A chemical sensor of the invention can be configured to monitor the ratio of IR absorption at two or more wavelengths one or which is a reference wavelength. A chemical sensor of this invention can be configured to monitor the ratio of IR absorbance at one or more wavelengths characteristic of one or more target analytes to IR absorbance at a reference wavelength.

Sensors of this invention can be employed as component sensors in sensor arrays and in sensor systems. Sensors of this invention can be employed as point sensors in sensor arrays for detection of one or more target analytes at multiple locations in a selected area covered by the sensor array. Sensors of this invention are useful in a wide variety of monitoring applications including environmental sensing and defense and security sensing applications.

The invention further provides sensor systems which comprise one or more sensors of this invention for detection of one or more target analytes and an actuator responsive to the detection of the one or more target analytes wherein the actuator initiates or triggers an event in response to detection of the one or more analytes. The event actuated may be an auditory or visual alarm. The event actuated may be the opening or closing of a door or window. The event actuated may be starting or turning off a fan, pump or other device which affects air circulation.

The invention provides a sensor array which comprises one or more chemical sensors of this invention. A sensor array can comprise at least one sensor which is configured to detect a first target analyte and at least one sensor which is configured to detect a second target analyte. A sensor array can comprise a plurality of chemical sensors each of which detects a different target analyte.

The invention further relates to methods for the detection of one or more target analytes in a selected environment. The invention particularly relates to the detection of such analytes in air. The invention also relates to methods for monitoring the concentration of one or more analytes in a selected environment, such as air. In these methods a chemical sensor of the invention is introduced into a selected environment such that target analytes that may be present in that environment are adsorbed into a sorbent polymer layer of the sensor. Thereafter IR absorbance at one or more wavelengths characteristic of each of the one or more target analytes to be detected is measured. The IR absorbance measurements can then be analyzed as is known in the art to determine if the one or more target analytes are present in the environment. In specific embodiments, the method of the invention detects the presence of one or more target analytes selected from the group consisting of a chlorinated hydrocarbon, an organophosphorous compound and a nitroaromatic compound.

The invention also provides a method for determining the concentration of one or more target analytes in an environment, such as air or another gas, which comprises the steps of introducing a chemical sensor of the invention into the environment, measuring IR absorbance at one or more wavelengths characteristic of each of the one or more target analytes the concentration of which is to be determined and analyzing the IR absorbance measurements to determine the concentration of the one or more target analytes in the environment. In a specific embodiment, one or more ratios of IR absorbance are monitored. In another specific embodiment, one or more ratios of IR absorbance at one or more wavelengths characteristic of the one or more target analytes to an IR absorbance at a reference wavelength are monitored. In a specific embodiment, the methods of this invention can be employed to determine the concentration of one or more target analytes selected from the group consisting of chlorinated hydrocarbons, organophosphorous compounds and nitroaromatic compounds. In preferred embodiments, the sensors of this invention are employed to detect target analytes in a selected environment in real time. The sensors can be, but are not preferred, for use for detection of analytes in samples collected in an environment subjected to analysis in remote from that environment.

The sensor of this invention comprises one or more sorbent layers, which are preferably polymer and/or metal oxide sorbent layers. Preferred polymer sorbent layers are organic polymer layers which exhibit an affinity for adsorption of the one or more target analytes. Preferred metal oxide sorbents likewise exhibit an affinity for adsorption of the one or more target analytes. Preferred metal oxide sorbents adsorb the analyte such that at least a portion of the IR bands characteristic of the analyte remain detectable on adsorption. A useful sorbent polymer or metal oxide may selectively adsorb a given target analyte or class of target analytes on contact with air or other gas which contains those analytes. A useful sorbent may simply adsorb a range of species including the target analyte or analytes on contact with gases containing those analyte. Sorbents useful in the invention do not however, need to exhibit selective adsorption of a target analyte. Sorbent polymers useful in this invention include, among others, a polyolefin, polyisobutylene, an epoxy, a fluorinated epoxy, a poly-vinylchloride-co-vinylacetate-co-vinylalcohol and mixtures of poly-vinylchloride-co-vinylacetate-co-vinylalcohol with diethylene glycol adipate. Polymers useful in this invention may be copolymers, mixtures of two or more polymers, or block copolymers, among other types of polymeric materials.

The invention further relates to particular sorbent polymer materials and/or metal oxide sorbent materials which are useful in the sensors of this invention for the detection of VOCs and more particularly for the detection of CWAs.

The invention is further illustrated and exemplified by the following figures and detailed description.

### BRIEF DESCRIPTION OF THE DRAWINGS

FIG. 1 is a schematic illustration of a sensor of this invention.

FIG. 2 is a schematic illustration which contrasts the attenuation of the IR radiation from organic vapor in air versus that from the same organic species in a sorbent.

FIG. 3 is a schematic illustration of the experimental setup that was used to determine the sorption properties of polymer thin films exposed to analytes. This same system can be employed to examine sorptive properties of other sorbents.

FIGS. 4A-C are the gas-phase IR spectra of (A) perchloroethylene (PERC), (B) dimethyl methylphosphonate (DMMP), (C) 1,3-dinitrobenzene (DNB). Spectra such as these can be employed to determine which wavelengths to monitor during sensor measurements.

FIGS. 5A-C are the IR signal obtained for PERC, DMMP, and DNB, respectively, in air (dotted line) vs. polymer sorbents (solid line). Spectra such as these can be employed to determine which wavelengths to monitor during sensor measurements.

FIGS. 6A-C are graphs of IR absorbance versus analyte concentration for ca. 5 μm PIB, FE and PVCAA/DEGA thin films exposed to PERC, DMMP and DNB, respectively.

FIG. 7A is a graph of the response of the FE sorbent in relation to film thickness, and FIG. 7B is a graph of the response of the PVCAA/DEGA sorbent in relation to multiple thin films at a constant thickness of ca. 10 μm each.

FIG. 8 is a graph of the IR absorbance versus exposure time for ca. 5 μm FE (open circles) and PVCAA/DEGA (open squares) thin films exposed to 100 ppb DMMP and DNB, respectively.

FIG. 9 is a graph of the normalized IR absorbance versus exposure time for ca. 5 μm and 20 μm PVCAA/DEGA thin films exposed to 100 ppb DNB.

FIG. 10 is a graph of IR absorbance (the P—O stretch) of DMMP adsorbed into the anatase TiO₂ film contacted with 100 ppb DMMP in air. See Example 2.

FIG. 11 shows normalized IR absorbance versus exposure time for the anatase TiO₂ film exposed to 100 ppb DMMP in air. See Example 2.

### DETAILED DESCRIPTION OF THE INVENTION

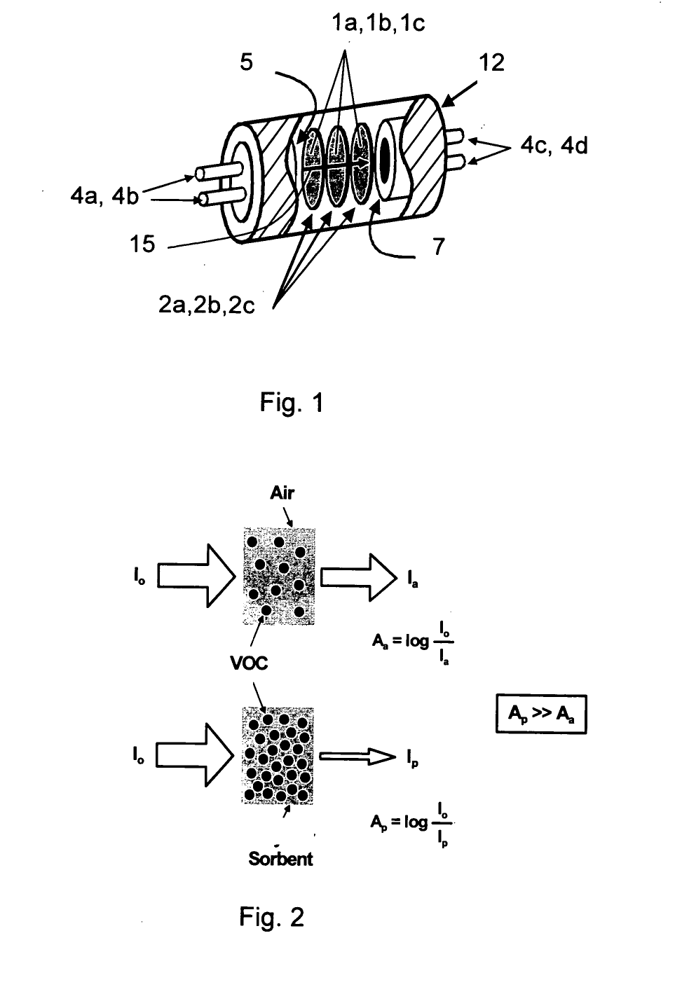

FIG. 1 illustrates an exemplary IR absorbance sensor (10) of this invention. The sensor illustrated is useful as a point sensor, or a component sensor of a sensor array. A plurality of such point sensors can be combined in a sensor array or sensor system for monitoring the presence and/or determining the concentration of one or more selected analytes throughout a selected area (e.g., where sensors are uniformly positioned throughout a designated area), at selected points in an area (e.g., where the sensors are positioned around a perimeter of an area) or at separate locations (e.g., where the sensors are positioned at a plurality of locations (e.g., rooms) in a building).

The sensor of FIG. 1 comprises an IR source (5), one or more sorbent layers (1a-1c) and an IR detector (7) More specifically, the IR source of the sensor of FIG. 1 is a solid-state IR emitter, such as a miniature, wirewound filament CW blackbody (1100 K) source available from Boston Electronics (Brookline, Mass.). The IR detector of the sensor of FIG. 1 is a multispectral IR detector. A useful multispectral IR detector, for example, is one which comprises one or more bandpass filters and a pyroelectric detector. More specifically, the IR detector is, for example, an InfraTec pyroelectric detector with added optical interference filters for various wavelength ranges, such as is from Laser Components (Santa Clara, Calif.). Preferably any detector that operates at ambient temperatures without cooling below about 0° C. is used. In a specific embodiment, the detector is an ambient temperature pyroelectric detector, and more specifically a DTGS pyroelectric detector.

One or more sorbent layers each deposited on an IR transparent substrate (2a-2c) are positioned between the IR source and IR detector such that IR wavelengths emitted by the source and absorbed by analytes adsorbed in the polymer sorbent layer(s) are detected in the IR detector. The substrates comprise two preferably substantially parallel surfaces for carrying one or two sorbent layers. The substrates are mounted in the sensor such that IR light from a source intersects the sorbent carrying surface(s) so that any analytes adsorbed therein can absorb IR wavelengths. The substrates are preferably mounted in the sensor such that the surface(s) carrying the sorbent are substantially perpendicular to the direction of propagation of the light (optical pathway, 15) in the sensor.

These elements of the sensor are preferably contained within a gas-permeable chamber (12), such that gas in contact with the outer wall of the chamber penetrates into the chamber to contact the polymer sorbent layer(s). The illustrated gas-permeable chamber is a sintered-metal sample chamber which can, for example, be fabricated from a tube of the sintered metal, such as is available from Chand Eisenmann Metallurgical, Inc., Burlington, Conn.

The substrates (2a-2c) carrying the sorbent layers are supported, spaced apart form each other, in the chamber in the optical path of the IR irradiation emitted from the source such that the IR irradiation passes thought the sorbent layers on the substrates and thereafter is detected by the IR detector. The substrates can be supported by any appropriate mechanical or adhesive support compatible with the measurements to be performed and the environments into which the sensor is to be introduced. It will be appreciated that materials and device elements employed in a chemical sensor of this invention are all selected to be compatible with and appropriate for the measurements to be performed and the environments into which the sensor is to be introduced. Sorbent layers may be formed on one or both surfaces of a substrate

Self-supporting sorbent layers, particularly sorbent layers comprising metal oxide can be employed directly in the sensor in place of, or in addition to, substrate supported sorbent layers. For example, thin pellets or discs comprising metal oxide can be formed and supported in the optical path of the sensor. Sorbent layers may also be supported at their periphery, for example by a metal or ceramic frame or other support. For example, a thin metal oxide layer may be formed by pressing metal oxide powder into a metal frame or grid.

Sorbent layers may also be formed from a mixture of metal oxide and polymer. Such mixed layers may be formed as thin layers or films on a substrate or may be self-supporting, particularly when higher amounts of metal oxide are present. Another alternative is that a sorbent metal oxide can be formed into a self-supporting layer (thin pellet or disc) to function as an adsorbent substrate and a thin layer of sorbent polymer may be cast or otherwise formed on a surface of the metal oxide substrate. Another, but not preferred, alternative is to mix a metal oxide powder with a IR transparent material, such as an IR transparent salt (e.g., KBr) and form a pellet or disc from the mixture, for example, by application of appropriate pressure.

A sorbent layer may comprise multiple layers of different sorbent materials, for example a thin metal oxide layer may be sandwiched between two thin layers of polymer. The formation of multiple layers of sorbent material can provide a self-supporting multi-layered sorbent pellet or disc for use in the sensors herein. Configurations of sorbent layers other than those specifically described can be employed in a sensor of this invention with the proviso that IR light from the source must pass through one or more sorbent layers before it enters the detector.

The number of sorbent layers whether supported layers or self-supporting layers that can be employed in a given device will depend in large part on level of transparency of the sorbents and any substrates employed to carry sorbent layers in the IR region that is to be monitored. It has been found that polymer sorbent layers generally are less transparent in wavelength regions of interest than metal oxide layers. In general, up to thirty layers of one or more sorbents may be employed in a sensor. For sensors employing polymer layers, 1 to 10 and preferably 1-5 sorbent layers are preferred. For sensors employing metal oxide layers, 1-30 and preferably 1 to 20 layers (particularly self-supporting or peripherally supported sorbent layers) can be employed. Sensors of this invention include those which comprise 2-10 sorbent layers where the sorbent may be the same or different.

Power is supplied to the IR source and detector through leads (4a-d) shown in FIG. 1. Power can be supplied from an external power source or may be provided through a battery or other portable power supply (not shown). Output signal from the detector is conveyed, after optional signal amplification or conversion to a microprossesor, computer and/or display (e.g., a visual display, auditory display). Methods and means for signal amplification and conversion and are well-known in the art and can be readily adapted for use in the sensors and sensor arrays herein.

Signals from the IR detector can be converted into concentrations by application of appropriate calibration tables or equations incorporated into memory of a microprocessor or computer as is understood in the art. Methods for performing calibrations appropriate for use with IR absorption measurement are known in the art and can be employed or readily adapted to the devices and methods herein.

The chemical sensor of FIG. 1 is placed in a selected location to detect the presence or determine the concentration of one or more selected analytes, e.g., one or more infrared active VOCs, in the air at that selected location. Air containing any such analytes penetrates the gas-permeable chamber of the sensor and analytes in the air are adsorbed into the polymer sorbent layer(s) in the sample chamber. The solid-state source enables IR radiation to be transmitted through the sample chamber where analytes, absorb photons at specific characteristic wavelengths. The concentration of analytes of interest is significantly higher in the sorbent layers than in the air. The multispectral IR detector is configured so that the passbands of the detector coincide with the absorption wavelengths of the analyte(s) of interest. In a specific embodiment, a reference wavelength is used to accurately and precisely determine analyte concentration based on the ratio of the two signals. The sensor can be configured to continuously or periodically monitor the concentration of one or more analytes of interest. The sensor can be configured to actuate some event in response to detection of a target analyte or on determination that the concentration of a target analyte has increased above a maximum level. For example, the sensor can be configured to actuate a warning signal (e.g., visual or auditory alarm) if the concentration of one or more analytes of interest varies outside of a selected range.

In a specific embodiment, the sorbent is provided in the sensor in multiple thin layers rather than in a single thicker layer. More specifically, the sensor of this invention comprises two or more sorbent layers, particularly polymer layers, each of which is supported on an IR transparent substrate. The supported sorbent layers generally range in thickness from about 0.01 micron to about 100 microns dependent upon the sorbent employed. Preferably, the supported sorbent layers range in thickness from about 0.1 to about 20 microns, more preferably the sorbent layers range in thickness from about 0.1 to about 10 microns. Preferred sorbent layers are less than about 20 microns thick. In general, the use of multiple thinner layers is preferred over the use of fewer thicker layers to achieve improved sensor response times. Sensors of the invention include those which comprise 3 or more, 4 or more, 5 or more, 6 or more, 7 or more, 8 or more, 9 or more or 10 or more of such sorbent layers.

In a specific embodiment, the substrates carrying the sorbent layers are positioned with sorbent layers parallel and the substrates are spaced apart from each other to facilitate adsorption of analytes from gas (e.g., air) that penetrates into the sample chamber. The diameter of the substrate is limited by the size of the sintered metal can or other housing that holds the substrates, preferably less than 2 cm diameter. Circular substrates are shown in the embodiment here, but any other cross-sectional planar geometries which allow radiation to pass through in a similar manner will work as well. Substrate thicknesses would preferably be as thin as possible to provide adequate support with minimum attenuation of IR frequencies of interest for detection, preferably substrates are less than 1000 microns.

In general, any IR transparent material that is compatible with the sensor application can be employed as a substrate for carrying a polymer or metal oxide sorbent layer. A useful substrate is one that has sufficient mechanical strength to support such a sorbent layer, is chemically compatible with the sorbent; is chemically stable in the presence of analytes of interest; is chemically and physically stable at the temperatures, pressures and in chemical environment in which sensor is to be positioned and allows formation of a polymer layer of desired thickness. Materials that can be employed include, among others, common IR-transmissive salts, such as KBr, AgBr, AgCl, CdTe, Ge, sapphire, and ZnSe. Material needs to be sufficiently thin not to substantially attenuate the beam of IR radiation itself. Additionally, the sorbent layer may be formed on substrate that is not itself IR transparent, but which is formed into a substantially IR transparent element; such as a perforated sheet or plate, an open pore network, a grid, or a mesh or related structural form. For example, thin, flexible silver halide sheets (approximately 100 microns thick) composed of AgBr on an inert structure can be employed as substrates.

Substrates may be planar or may be curved (concave or convex) and may have smooth or rough, indented or flat surfaces, so long as the polymer layer can be applied to the substrate. Sorbent layers can be coated on one or both sides of a planar substrate.

The terms layer and film are used interchangeable herein to refer to the sorbent element which may be a thin layer or film on a substrate. The sorbent layer may also be formed as a coating on one or more surfaces of a substrate. The sorbent element may also be in the form of a self-supporting pellet or disc with thickness as described herein, but that has sufficient thickness to be self-supporting (to withstand normal vibrations and other movement that typically occurs in electronic devices). The sorbent element can be a thin disc or pellet which is formed in a support (that may or may not be IR transparent). For example, the sorbent element may be a disc that is pressed into a metal or ceramic holder or grid. Thus, the sorbent element may be supported peripherally (around at least a portion of the periphery of the element) in a holder or grid. Non-IR transparent supports are positioned to hold the sorbent element in the optical path of the sensor without significantly blocking or otherwise attenuating light passing through the sensor.

In general, the sorbent is selected to have an affinity for adsorption of the one or more analytes of interest. A number of polymer sorbents are known in the art to be useful for adsorption of one or more analytes, including those polymers which have been studied (as noted in references cited herein) for use in chemical sensors other than those of this invention. McGill and Grate³² provide a method for selecting polymers as sorbents which is based on prediction of partition coefficients. This method is further discussed in published U.S. patent application 2002/0192836. This published application and the McGill and Grate reference are specifically incorporated by reference herein for descriptions of selection of polymer sorbents for a given analyte of interest.

In contrast, to other types of chemical sensors which employ polymer sorbents, the polymer of the sensor of this invention does not need to be extremely selective for adsorption of the analyte(s) of interest, because the wavelength-selective spectroscopic detection method supplies the necessary selectivity. Instead, a polymer is engineered or selected to substantially transmit IR radiation in the wavelength regions in which the one or more analytes of interest absorb. Preferably the polymer substantially transmits IR radiation between about 4000 cm⁻¹ to 400 cm⁻¹. The polymer is further selected to rapidly absorb analytes of interest. Of particular interest for use in sensors for CWAs and ERCs are polymers that rapidly absorb these species such that they are present in the polymer sorbent layer at a significantly higher concentration than the bulk air phase.

In general any metal oxide that adsorbs of one or more target analytes of interest can be used as a sorbent in this invention. A number of metal oxide sorbents are also known in the art to be useful for the adsorption of one or more analytes. All such metal oxides which meet other transparency and reactivity requirements as noted herein can be employed as sorbents in the sensors herein. Metal oxide sorbents include those that adsorb the analyte non-dissociative. Adsorption may be reversible such that the analyte can be desorbed by flushing with a gas or heating the surface or the analyte may be decomposed on removal from the sorbent. Enhanced sensitivity for detection of certain analytes has been observed in sorbent layers formed from amorphous metal oxides. In particular, amorphous TiO₂ exhibits enhanced detection sensitivity for certain analytes.

Preferred sorbents exhibit at least a 10-fold enhancement in concentration of an analyte (compared to its concentration in the gas contacting the sorbent). More preferred sorbents exhibit a 50 fold or more enhancement in concentration. The response characteristics of the chemical sensor (i.e., sensitivity, response time, dynamic range, etc.) are adjusted, as needed, by optimizing the physical properties of the sorbent.

FIG. 2 is a schematic illustration which contrasts the attenuation of the IR radiation from organic vapor in air versus that from the same organic species in a polymer sorbent. The absorbance, A, is defined as the log of the ratio of the incident IR radiation, Iₒ, divided by the IR radiation transmitted through either an air, Iₐ, or a polymer, Iₚ, medium of defined thickness (Ingle and Crouch, 1989).²⁰ It has been found that the attenuation of the IR radiation can be increased between 25 to 10,000 times in a sorbent, particularly a polymer sorbent, versus air. This result indicates that IR point sensors for detecting VOCs can achieve ppb detection limits.

A variety of gas sorbent materials are known in the art. Sorbents useful in the sensors herein exhibit reversible adsorption of one or more target analytes so that the concentration adsorbed is indicative of the concentration of the one or more target analytes in the medium, e.g., gas that is in contact with the sorbent. Preferred sorbents exhibit relatively fast equilibration of the adsorbed analyte as a function of changing concentrations of the analyte in the medium in contact with the sorbent layer such that the sensor exhibits fast response times.

A variety of polymers sorbents are known in the art. Information on adsorption by such polymers can be employed to select polymer materials for adsorption of a given target analyte or class of target analytes. The development of FE and PVCAA/DEGA sorbents used in certain examples herein was accomplished using knowledge of bulk-phase chemical interactions²¹⁻²³ along with previous research studies for detecting CWAs and ERCs.²⁴⁻²⁷ For example, synthesis of the FE sorbent was based on previous chemical sensor research studies employing fluoropolyol as a sensitive and selective material for detecting organophosphorus-based CWAs, whereas the PVCAA/DEGA sorbent was chosen based on its affinity toward nitroaromatic compounds. It will also be appreciated by those of ordinary skill in the art, that polymers may be assessed for their usefulness for adsorption of a given target analyte by measurement of the partition coefficient (described below) for that target analyte. The determination of such partition coefficients is a technique that is known in the art.

Additional desirable properties for sorbents include high permeability to a specified target analyte with fast absorption rates. The physical properties that normally accompany polymer sorbents with the necessary performance characteristics include low density, low crystallinity, and rubbery properties. The general mechanism of an organic vapor interacting with a sorbent can be described by its partition coefficient, K, as defined by Equation 1:²¹

$$K = \frac{{C}_{p}}{{C}_{a}} \qquad ( 1 )$$

where Cₚ is the concentration of the analyte in the polymer and Cₐ is the concentration of the analyte in the air. The chemical process that governs the sensitivity of polymer sorbents is very similar to the solution process for organic vapors interacting with liquid solvents. When a sorbent is exposed to an organic vapor, a thermodynamic equilibrium is established between the sorbent and air phases. The partition coefficient is simply a measure of the overall interaction strength of the analyte in the sorbent versus air.

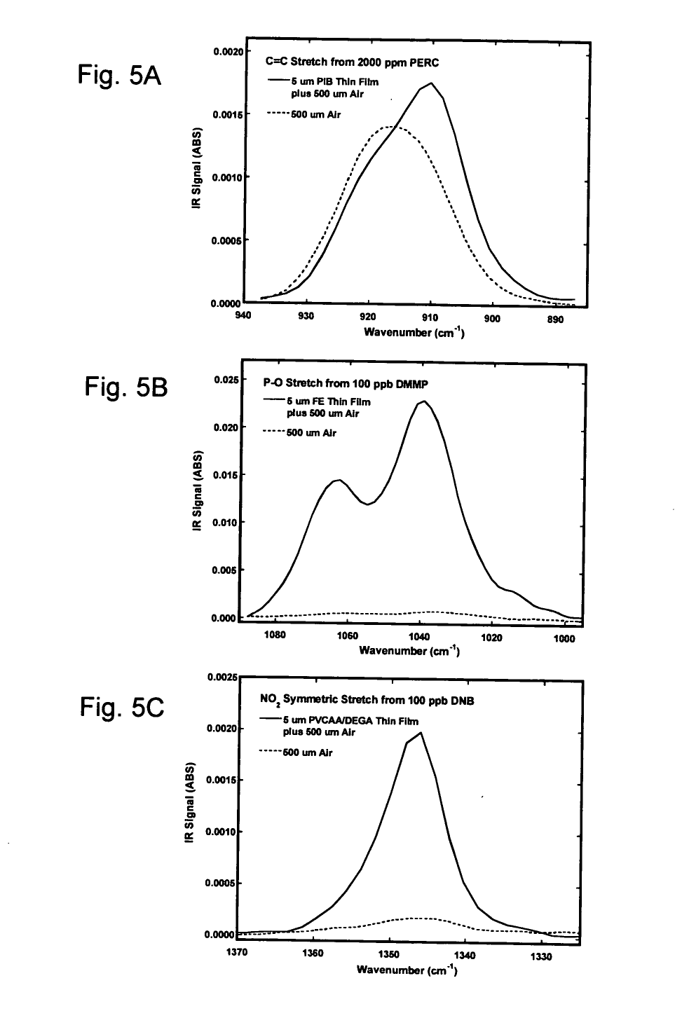

As illustrated in FIGS. 5A-C, this well established principle is being used to reduce the pathlength of the IR sensors while increasing the sensitivity and selectivity to the desired analyte.

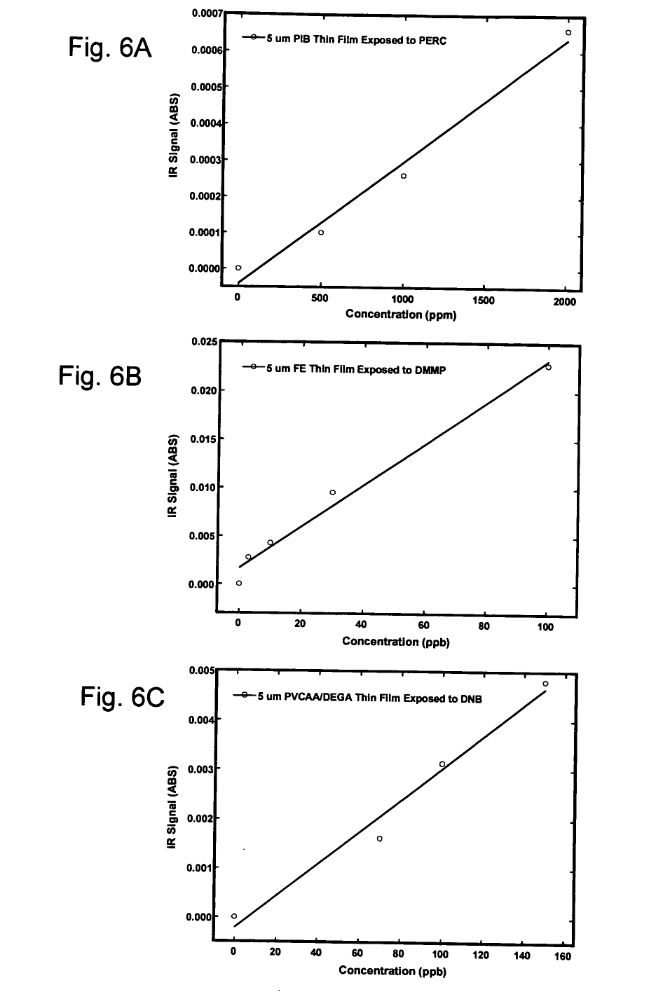

FIGS. 6A-C show the magnitude of the IR absorbance versus the analyte concentration for ca. 5 μm PIB, FE and PVCAA/DEGA thin films exposed to PERC, DMMP and DNB, respectively. As expected from Beer's Law, the magnitude of the IR absorbance is proportional to the concentration of the organic analyte in contact with the sorbent. These data demonstrate the capability of three distinct polymer sorbents and analyte combinations.

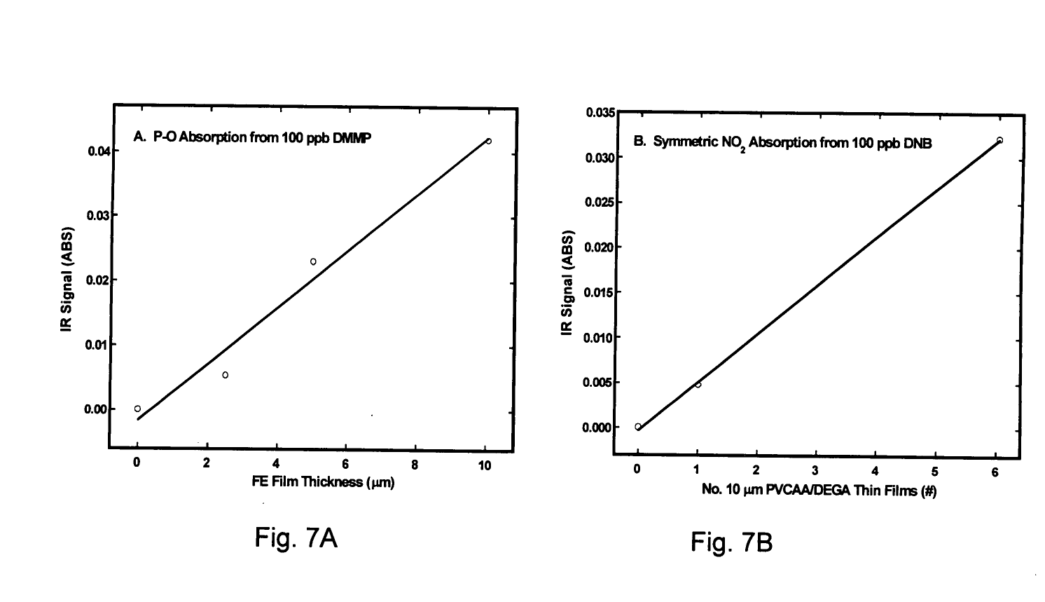

Two approaches can be used to enhance the sensitivity of sorbents even further, as shown in FIGS. 7A and B. FIG. 7A shows the response of the FE sorbent in relation to film thickness, and FIG. 7B demonstrates the response of the PVCAA/DEGA sorbent in relation to multiple thin films at a constant thickness of ca. 10 μm each. The analyte concentration for these experiments was 100 ppb. These results illustrate that the measured IR absorbance can be enhanced by simply increasing the thickness of a single polymer thin film or by increasing the number of polymer films of constant thickness.

Metal oxides have many beneficial properties when used as sorbent layers. Metal oxide materials are rugged and often transmit sufficient amounts of infrared radiation when cast as thin films or used as discs. Generally preferred metal oxides for use as sorbents include oxides of Ti, Zn, Ce, Sn, Fe, Al, Si, Ga, LA, Nb, PB, Mg, Zr, W, V, Cr, Ni, Cu, Y, Sr, Co and mixtures of such oxides. Specific preferred oxides include various forms of ZnO, CeO₂, TiO₂ (amorphous, rutile or anatase), SnO₂, Fe₂O₃, Al₂O₃, SiO₂, Ga₂O₃, La₂O₃, Nb₂O₅, PbO₂, MgO, ZrO₂, WO₃, V₂O₃, Cr₂O₃, NiO, CuO, Y₂O₃, SrO, CoO and mixtures of such oxides.

The stoichiometry of the metal oxide can be selected to improve sensing properties. Oxides with varied stoichiometries are available for commercial sources or can be prepared by well-known methods. For example, several oxides of titanium metal exist, e.g., TiO, TiO₂, Ti₂O₃, Ti₃O₅, and Ti₄O₇. These differing oxides of the same metal or of a different metal, can exhibit differing adsorption characteristics which may be useful for analyte adsorption due to the presence of stronger or more selective binding sites. Metal oxides can have different crystal structure which can exhibit different adsorption characteristics For example TiO₂ is can be formed in anatase, rutile, or brookite crystallographic forms or it can be amorphous. A particular structure or form of the oxide can be more useful in binding a VOC of interest. It have been discovered that TiO₂ in the amorphous form exhibits enhanced detection of certain analytes compared to anatase TiO₂. A thin film composed of amorphous TiO₂ (evaporated from a 0.025 g TiO₂/2 mL isopropanol suspension) displayed a 5 fold increase in response to 100 ppb DMMP compared with an anatase TiO₂ film prepared in the same way.

Metal oxide powders can be doped with metals to further enhance adsorption properties of metal oxide sorbent layers. Metal dopants can modify the chemical reactivity of the oxide surface either through electronic interactions with the substrate or through the production of new metallic binding sites. Also, metallic dopants can reduce sensor response times. Dopants can be added to oxide powders through processes, such as sputtering or wet-chemical methods (coprecipitation, deposition-precipitation, etc.). Non-limiting examples of useful metal dopants include, among others: Pt, Pd, Au, Cu, Ru, Ni, Ag, Fe, Cr, Os or combinations or two or more of these metals. Doping levels from about 0.01 to about 10% by weight of metals can be employed.

Metal oxide and metal-doped metal oxide sorbent layers can be formed by any method known in the art for forming thin films of layers of such materials.

A given analyte may form the same or different adsorption complexes on a given sorbent or on different sorbents.

In specific embodiments, the polymer sorbents employed in this invention are polymers other than conductive polymers. In specific embodiments, the metal oxide sorbents herein exhibit chemisorptive and/or physisorptive adsorption of the analyte of interest. In specific embodiments, the sorbents herein exhibit selective adsorption of an analyte or class of analytes of interest where the enhancement of selectivity of adsorption of the analyte or analytes ranges from about 5% to 50% or more. In a specific embodiment, the metal oxide sorbent employed does not chemically modify the analyte on adsorption. In specific embodiments herein the sorbent layer does not contain a dye, and particularly does not contain a fluorophore.

In preferred embodiments the sensors of this invention exhibit sensitivity for a selected analyte of 100 ppb or less. Sensors herein can exhibit sensitivity for a selected analyte between about 1 ppb and 100 ppb for a given analyte. Sensors herein can exhibit sensitivity less than 1 ppb for a given analyte. As will be appreciated, sensitivity of a given sensor may vary dependent upon the analyte to be detected and measured. Additionally, sensitivity for a given analyte may be optimized by selection of sorbent material and thickness of the sorbent layer.

The sensors herein can have device configurations other than those specifically exemplified. For example, the sorbent elements and layers herein can be employed with both dispersive (grating or other type of dispersive system) and nondispersive (interferometric, photometric systems) spectroscopic hardware. Dispersive and nondispersive systems are known in the art and can be readily implemented with the sensors herein. A photometer configuration is one in which the incident radiation is passed through filters (bandpass or others) to select a wavelength region in which to monitor absorbance changes. A photometer configuration of the sensors herein will be generally preferred because of its lower cost for implementation.

The sensors herein may be combined with various optical devices including wavelength filters, lens, reflectors, splitters and the like, the operation of which are well-known in the art to implement desired device configurations.

Chemical sensors of this application have a variety of commercial and military applications. For example, the development of IR point sensors for CWAs and ERCs can dramatically impact both military and commercial applications. Specific applications include chemical defense systems for military personnel and homeland defense, environmental monitors for remediation and demilitarization, and point source detectors for emergency and maintenance response teams. As discussed in this paper, the performance characteristics of proprietary sorbent materials exposed to DMMP and DNB is enabling the development of these novel sensors, which will provide many of the same benefits as chemical micro sensors (i.e., small rugged components that are mass producible using batch fabrication techniques) along with a highly selective detection strategy found in expensive, high performance NDIR analyzers. Once commercialized, these innovative sensors would enhance the capabilities of federal, state, and local emergency response to incidents involving chemical terrorism. Additional studies will be needed to determine the effect of temperature on the sensor's performance in field applications, since partitioning of analyte into the polymer film is expected to be temperature dependent. The main technical benefits being realized include superior performance, lower cost, reduced power requirements, and improved portability compared to commercially available instruments. The lack of small, reliable, and inexpensive instruments has made CWA and ERC measurements both difficult and costly for field-deployable and remote applications.

Various methods and techniques for the analysis of infrared absorption data are known in the art and can be employed in the practice of this invention. For example, methods for signal amplification, signal conversion, signal averaging, and signal comparison are known in the art and can be employed or readily adapted for use in the sensors, sensor arrays and sensor systems herein.

Certain sensors and methods of this invention rely upon the measurement of IR absorption intensity at one or more wavelengths characteristic of a target analyte or a class of target analytes. The presence of an absorption at one or more characteristic wavelengths in the IR spectral region allows identification of a target analyte or a class of target analytes. Gas phase IR absorption spectra of a wide variety of potential target analytes are known in the art and/or can be readily determined by well-known techniques. Such spectra can be used to obtain or determine IR absorption wavelengths that are characteristic of a target analtye or class of such analytes. As is known in the art, detection of an IR absorption characteristic of the presence of a functional group or a bond, such as that of a symmetric or asymmetric stretch of a nitro group, indicates the presence of a compound containing the functional group or bond associated with that characteristic IR absorption. IR absorption wavelengths characteristic of a given functional group or bond may vary dependent upon the molecule in which the group or bond is found. This is well-known in the art and the wavelength ranges over which IR absorptions associated with different IR active absorptions (e.g., various stretches and bends) are generally known in the art and available from of number of well-known compilations of such information. Furthermore, the IR absorption wavelengths characteristic of a given functional group or bond in a target may shift or broaden on adsorption of the analtye into a sorbent polymer.

Chemical sensors of this invention can be configured by choice of IR source and IR detector to be capable of detecting IR absorption at one or more wavelengths or ranges of wavelengths. Chemical sensors of this invention can be configured to detect changes in intensity of any IR absorptions at one or more wavelengths or ranges of wavelengths. Chemical sensors of this invention can be configured to detect the presence of or any changes in intensity of any IR absorptions within a selected range of wavelength in which an IR absorption characteristic of a target analyte or class of such analytes would likely occur. There may be more than one IR absorption wavelength that is characteristic of a given target analyte or it may be necessary to measure absorption at more than one wavelength to distinguish between or among different potential analytes. In such cases, a chemical sensor can be configured to detect or monitor IR absorption at multiple wavelengths. Similarly, if a chemical sensor is intended to detect multiple target analytes, the sensor can be configured to detect or monitor IR absorption at multiple wavelengths. Chemical sensors of this invention, in specific embodiments, are configured to monitor changes in a ratio of IR absorbance at two different wavelengths. The ratio monitored may compare IR absorbance at a wavelength characteristic of a target analyte to that at a reference wavelength where that target shows insignificant absorbance. The ratio monitored may compare IR absorbance at two different wavelengths characteristic of the same target analyte or at two different wavelengths each characteristic of a different target analyte.

Substrates employed in the sensors of this invention are IR transparent. This term is used herein to mean that the substrate is sufficiently transparent over a sufficient portion of the IR spectrum to allow detection or monitoring of the IR wavelengths characteristic of the one or more target analytes that a given chemical sensor is intended to detect or monitor. Preferred substrates are those which exhibit sufficient IR transparency over the broadest IR spectral range. Various IR transparent materials are known in the art. Additionally, a substrate material which is not IR transparent can be generated in a form which provides sufficient IR transparency, such as in a perforated form, a grid, a mesh or a web. It will be appreciated that the substrate is intended to support a sorbent layer and that IR absorption is to be measured by passing IR radiation through the sorbent layer. The substrate must provide sufficient mechanical strength to support the selected polymer sorbent layer.

Chemical sensors of this invention are preferably employed for detection and monitoring of IR absorption in the mid-IR (MIR) i.e. wavelengths in the range 2-20 microns.

Sorbent materials may be cleaned prior to and/or after use to remove adsorbed chemical species, particularly any adsorbed analyte and to regenerate an active surface for future adsorption. Sorbents may be heated (to a temperature that is not detrimental to the sorbent itself) to facilitate such desorption and cleaning. Such treatment can allow for more rapid sensor recovery times. One or more heating elements can be provided in the sensor to apply heat to the sorbent elements therein.

Another method to ensure sensor reproducibility is to pretreat the sorbent prior to sensing with the analyte of interest followed by a purge cycle using preferably air (or nitrogen or an inert gas). A range of pretreatment concentrations can be employed, for example the sorbent can be pretreated by exposure to concentrations of the analyte of interest ranging from 1 ppm to 100 ppm for a time that provides the desired reproducibility particularly from about 10 minutes to 1 hour. Irreversibly bound adsorbates would adhere during this process, and can be removed from subsequent analysis using background subtraction techniques. By doing this, the observed response and recovery times of the sensor can be improved.

When a group of materials, compositions, components or compounds is disclosed herein, it is understood that all individual members of those groups and all subgroups thereof are disclosed separately. It is also understood that one or more members of a listed groups may be excluded from that group. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. The term “about” when employed in combination with a numerical value, e.g., about 20, is intended to encompass the specific numeric value listed (e.g., 20) and a range of values higher and lower than the value listed. For clarity the term about herein refers to a range that extends from 10% higher to 10% lower than the specific value listed.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

The invention illustratively described herein suitably may be practiced in the absence of any element or elements, limitation or limitations which is not specifically disclosed herein.

One of ordinary skill in the art will appreciate that materials, substrates, device elements, light sources, light detectors, methods of preparation of thin films, methods for measurement of film thickness, methods for characterization of films, optical calibration methods, spectroscopic methods and analytical methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art. For example, when a compound or composition is claimed, it should be understood that compounds and compositions known in the art including the compounds disclosed in the references disclosed herein are not intended to be included in the claim.

All references cited herein are hereby incorporated by reference herein in their entirety. Some references provided herein are incorporated by reference to provide details concerning sources of sorbent polymers, sources of sorbent metal oxides, additional device elements, additional methods of data analysis and additional uses of the invention.

### THE EXAMPLES

### Example 1

### Polymer Thin-Film IR Sensors

Materials

Unless otherwise noted, all chemicals were purchased from Aldrich. A formulation of a fluorinated epoxy (FE), which was designed to enhance the response of organophosphorus-based CWAs, was synthesized as described below from commercially available materials. Diglycidyl ether of bisphenol F (DGEBF) was reacted with the diol α,α,α′,α′-tetrakis(trifluoromethyl)-1,4-benzenedimethanol in refluxing 1-butanol, in the presence of a catalytic amount of tributylamine and varying mole percentages of a reactive diluent (styrene oxide) to reduce the crosslinking density of the product for improved properties. Use of from about 25 to about 55 mole percent of styrene oxide afforded soluble, processable materials.

A formulation of poly-vinylchloride-co-vinylacetate-co-vinylalcohol (PVCAA) (from Aldrich Chemicals) and diethylene glycol adipate (DEGA) from Ohio Valley Specialty Chemicals was used to enhance the permeability of ERCs employing nitroaromatics. The films were prepared by adding DEGA to 30 mg/mL PVCAA in THF to obtain a final weight percentage of 50-80% DEGA and correspondingly, 50-20% PVCAA. Organic solvents used to cast thin films of polymer sorbents on IR transparent substrates were reagent grade and used as received. Dimethyl methylphosphonate (DMMP) was used to simulate the response of CWAs (i.e., GB and VX), and 1,3-dinitrobenzene (DNB) was used as a model ERC. PERC (perchloroethylene, also called tetrachloroethylene) was used as a model VOC and model chlorinated hydrocarbon. Zero grade air for a dynamic test system and ultra high purity nitrogen for purging a Nicolet FTIR spectrometer were obtained from Air Gas.

Polymer Film Preparation

Polymer thin films ranging in thickness from approximately 2 μm to 30 μm were applied to infrared transmissive windows (e.g., KBr and AgBr) using a Headway spin coater. Isopropanol was used as the carrier solvent for preparing FE thin films, and tetrahydrofuran was used as the carrier solvent for preparing PVCAA/DEGA thin films. Film thickness is adjusted as is known in the art by changing the concentrations of solutes in the solution employed in spin coating. Higher concentrations yield thicker films for a constant volume of solution applied. Film thickness can be measured by any method known in the art. For example, stylus profilometry can be employed. This technique can be employed to readily measure thicknesses in the range 0.1 to 100 microns. Additionally, IR absorptions of the polymer itself can be used to assess film thickness or the weight of deposited polymer (if the density and deposit area are known) can be used to assess thickness. Additionally, SEM of freeze-fractured film cross-sections can be used to estimate the thickness of a polymer layer.

Measurements

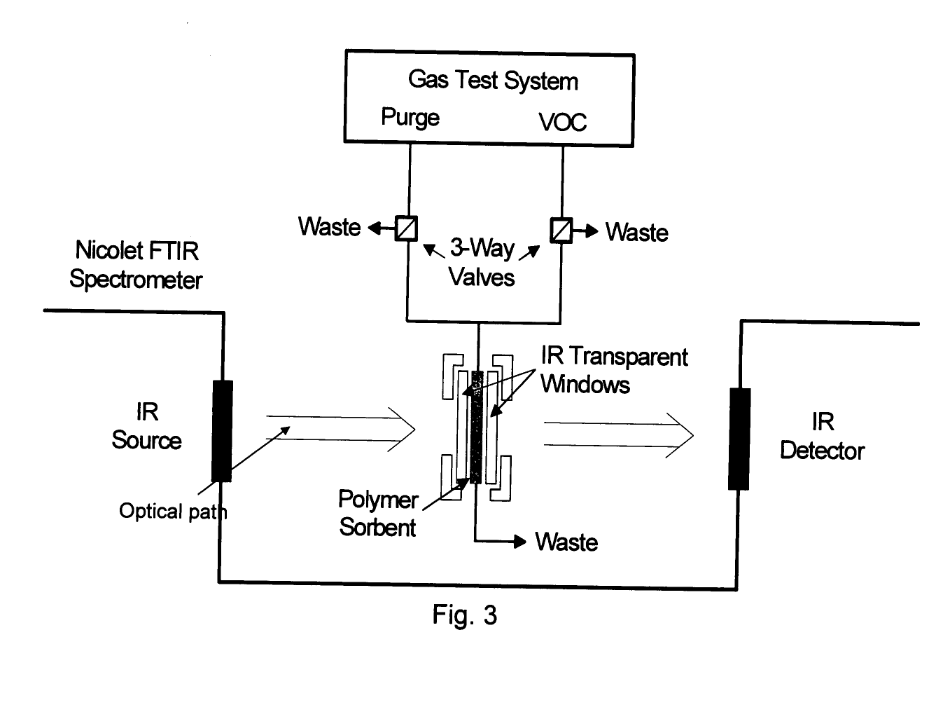

FIG. 3 shows the experimental setup that was used to determine the sorption properties of polymer thin films exposed to DMMP and DNB. All measurements were performed using a Nicolet Impact FTIR at ambient conditions. A gas test system employing a series of mass flow controllers was used to generate purge and analyte gas streams. The gas test system was configured to produce analyte vapors ranging in concentration from 0 ppb to 100 ppb. Concentrations of DMMP delivered to the FE polymer sorbent were calibrated with a Shimadzu gas chromatograph (GC). Reference standards were prepared based on published values of the vapor pressure for DMMP along with the volume of air sampled in the headspace of a sealed vial containing this analyte. Concentrations of DNB delivered to the PVCAA/DEGA polymer sorbent were calibrated using a Shimadzu thermal gravimetric analyzer (TGA) at constant temperature and flow rate conditions identical to the experimental conditions for thin film absorption measurements. The average gas phase concentration of DNB was determined from TGA weight loss per unit time and the flow rate of air over the sample. FTIR measurements were performed by acquiring 16 scans at 8 cm⁻¹ resolution from 4000 cm⁻¹ to 400 cm⁻¹. Three-way solenoid valves were used to direct either purge or analyte gas streams through an IR Test Cell which was specifically designed and fabricated for performing these types of measurements. Background measurements were performed by flowing purified air through the IR Test Cell. Sample measurements were performed by flowing analyte in purified air through the IR Test Cell. The ratio of these two measurements was used to generate detailed spectral data. This approach enabled polymer thin films to be exposed to a continuous gas flow during the entire experiment. Moreover, it enabled accurate measurements of the absorption and adsorption properties for the polymer thin films.

IR Spectra of Organic Analytes

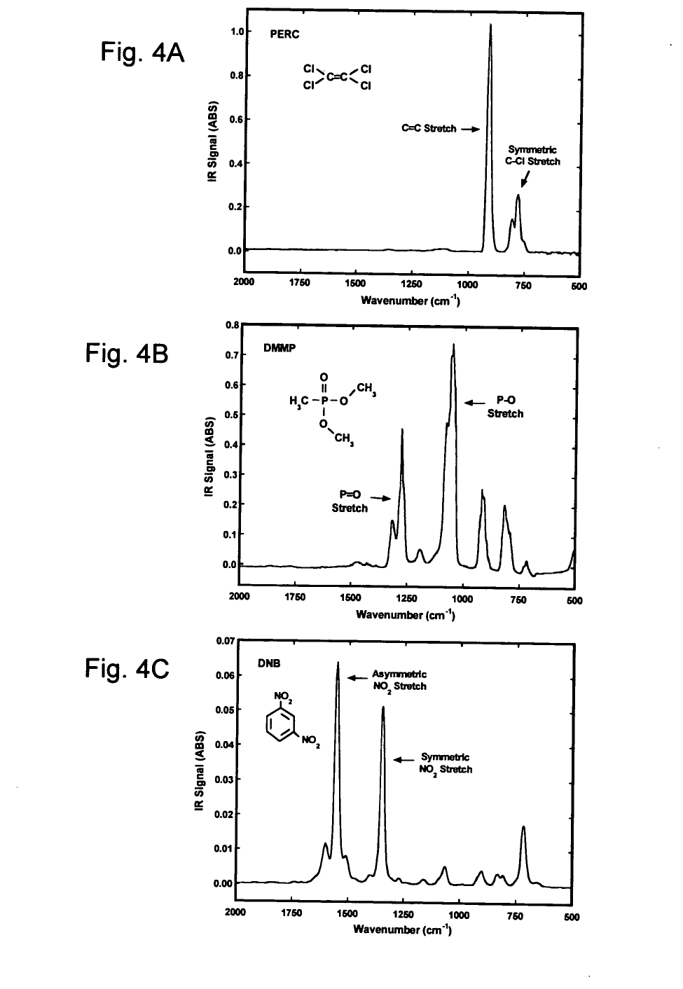

FIGS. 4A-C show the gas-phase IR spectra of (A) perchloroethylene (PERC), (B) dimethyl methylphosphonate (DMMP), (C) 1,3-dinitrobenzene (DNB). PERC is a representative chlorinated hydrocarbon. DMMP is a model organophosphorous CWA. DNB is a representative nitroaromatic ERC. These data illustrate key regions in the mid-IR that can be used to identify specific organic analytes or classes of such analytes. For example, PERC has a characteristic asymmetric C—Cl stretch at 780 cm⁻¹ and a C═C stretch at 912 cm⁻¹. IR absorption due to C—Cl stretches can be used to identify chlorinated hydrocarbons. DMMP has a characteristic P—O stretch at 1046 cm⁻¹ and P═O stretch at 1245 cm⁻¹. IR absorption due to P—O and P═O stretches can be used to identify organophoshorous species. DNB has a symmetric NO₂ stretch at 1347 cm⁻¹ and an asymmetric NO₂ stretch at 1553 cm⁻¹. IR absorption due to symmetric and asymmetric NO₂ stretches can be used to identify organo compounds containing nitro groups, such as aromatic nitro compounds.

Enhancement of IR Absorbance with Polymer Thin Film Sorbents

FIGS. 5A-C shows the IR signal obtained for PERC, DMMP, and DNB, respectively, in air (dotted line) vs. polymer sorbents (solid line). The polymers were selected to enhance the local concentration of the desired analyte in the thin film. For example, a commercially available formulation of polyisobutylene (PIB) was used to detect PERC, a custom-synthesized fluorinated epoxy (FE) was used to detect DMMP, and a polymer mixture of commercially available poly-vinylchloride-co-vinylacetate-co-vinylalcohol (PVCAA) and diethylene glycol adipate (DEGA) plasticizer was used to detect DNB. PIB sorbent layers are formed by spin coating substrates using solutions of 0.5-10 weight percent PIB in toluene. FE sorbent layers are formed by spin coating substrates using solutions of 1-15% by weight FE in 1-butanol, isopropanol and other alcohols. PVCAA/DEGA layers are formed by spin coating substrates using solutions of poly(vinylchloride-co-vinylacetate-co-vinylalcohol) 10 to 50 mg/mL in tetrahydrofuran, mixed with diethyleneglycol adipate (DEGA) plasticizer to obtain final DEGA weight percentage in the range 20% to 80%. Sorbent layers formed using 30 mg/mL PVCAA in tetrahydrofuran mixed with DEGA to obtain final DEGA weight percentage of 50-80% exhibited improved function.

FIGS. 5A-C clearly demonstrate that the amount of IR radiation absorbed from an organic vapor is increased using a polymer sorbent compared to an air gap of equal thickness. FIGS. 5A-C shows the IR signal enhancement for the C═C stretch of PERC (A) in a PIB thin film, the P—O stretch of DMMP in a FE thin film (B), and the symmetric NO₂ stretch of DNB in a PVCAA/DEGA thin film (C). The thickness of each polymer thin film was approximately 5 μm, and the concentrations of PEC, DMMP and DNB were 2000 ppm, 100 ppb, and 100 ppb, respectively. The pathlength of the air medium was 500 micron, which is 100 times the thickness of the polymer films. The magnitudes of the IR absorbances resulting from these films was determined to be 50, 3000, and 1500 times greater than air, respectively, based on the thickness of the polymer films, the thickness of the air medium, and the relative amount of IR radiation absorbed by the organic vapor.

Response of IR Absorbance Vs. Analyte Concentration

FIGS. 6A-C show the magnitude of the IR absorbance versus the analyte concentration for ca. 5 μm thick PIB (A), FE (B) and PVCAA/DEGA (C) thin films exposed to PERC, DMMP and DNB, respectively. Individual data points represent the steady-state magnitude of the C═C, P—O and symmetric NO₂ absorbances. The lines represent linear fits to the data.

As expected from Beer's Law, the magnitude of the IR absorbance is proportional to the concentration of the organic analyte. These data demonstrate that the utility of IR point sensors for three distinct polymer sorbents and analyte combinations. For example, current exposure standards for PERC include permissible exposure limits of 100 ppm, ceiling limits of 200 ppm, and peak limits of 300 ppm.²⁸ The data of FIG. 6A demonstrates that PERC can be detected over this concentration range with a PIB thin film. DMMP was used to simulate the response of organophosphorous nerve agents that require detection between 0.05 mg/m³ to 0.3 mg/m³ for battlefield applications.²⁹ For DMMP this concentration is equivalent to approximately 7 ppb to 40 ppb by volume. DMMP was detected with the requisite sensitivity by the FE thin film. DNB was used to illustrate the detection of an explosive related compound relevant to land mine detection. DNB was also reliably detected over the same concentration range as DMMP which will be adequate for certain DNB detection applications. Additional sensitivity enhancements will be beneficial for development of IR point sensor applications for DNB detection in surface soils over buried land mines which will likely require sub-ppt (part-per-trillion) detection.³⁰

As shown in FIGS. 7A and B, two approaches can be used to enhance the sensitivity of polymer sorbents to a target analyte. FIG. 7A shows the response of the FE sorbent in relation to film thickness, and FIG. 7B shows the response of the PVCAA/DEGA sorbent in relation to multiple thin films at a constant thickness of ca. 10 μm each. The analyte concentration for these experiments was 100 ppb. Data points represent the steady-state magnitude of the IR absorbances, and the solid line represents a linear curve fit of the data. Film thicknesses for the films from which these data were obtained were estimated based on a combination of representative cross-sectional SEM images, polymer film spin-coating parameters, and the relative magnitude of the IR signal from P—O and symmetric NO₂ absorbances. These results illustrate that the measured IR absorbance to organic vapors can be enhanced by simply increasing the thickness of a single polymer thin film or by increasing the number of polymer films of constant thickness employed. Based on Beer's law and the partition coefficient of an organic analyte interacting with a polymer sorbent, these results indicate that the absorbance from a thin film, or films, can be defined by Equation 2:^{5,6}
Aₚ=ε×K×t×Cₐ (2)
where ε is the molar absorptivity of the organic vapor in the polymer sorbent and t is the total thickness of the polymer sorbent. In other words, the steady-state magnitude of the IR absorbance for an organic analyte interacting with a 10 μm polymer thin film should be equivalent to the combination of ten 1 μm polymer thin films. As discussed below, this result becomes extremely important when fast response times are also necessary.
Response of IR Absorbance Versus Analyte Exposure Time

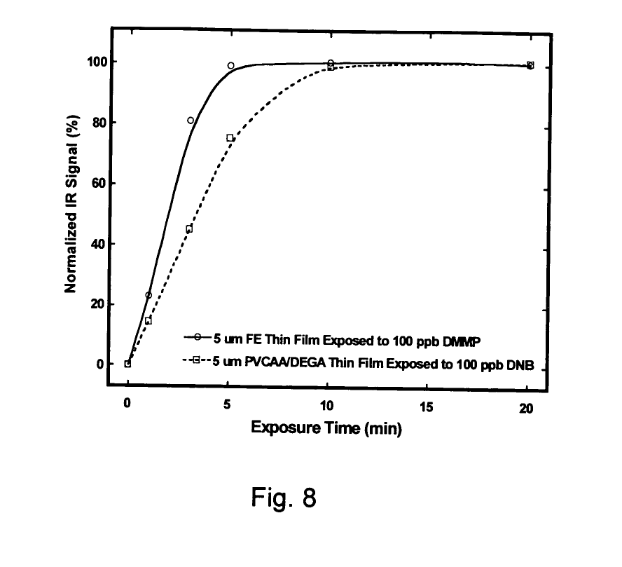

FIG. 8 shows the IR absorbance versus exposure time for ca. 5 μm FE (open circles) and PVCAA/DEGA (open squares) thin films exposed to 100 ppb DMMP and DNB, respectively. Individual data points represent the percentage of the steady-state magnitude for the P—O and symmetric NO₂ absorbances. Solid and dashed lines represent smooth curve fits. These data demonstrate the amount of time required to detect a positive signal from each analyte as well as the amount of time necessary to quantify the analyte concentration. For example, a statistically significant response (i.e., 3σ of the noise that corresponds to a 0.14% probability of a false positive signal) occurred in less than 1 min for both DMMP and DNB. The T₉₀ response time, or time required to reach 90% of the steady-state absorbance, was 4 min for DMMP and 8 min for DNB. Similar data a 5 micron thick PIB thin film exposed to 1000 ppm PERC (not shown) indicates a T₉₀ response time of 1 minute for PERC. Due to the importance of detecting CWAs and ERCs with low false alarm rates, fast response times are an important aspect of the development of IR point sensors.

The response time of the polymer sorbents can be further improved by minimizing the thickness of the sorbent layer. For example, the absorption of organic vapors in rubbery polymers can be described by Fick's first law of diffusion, as defined by Equation 3:³¹

$$N = - D \times \frac{ⅆ {C}_{a}}{ⅆ x}$$

where N is the permeation flux, D is the diffusion coefficient of the organic vapor in the polymer sorbent, and x is the distance of the permeating vapor molecules. Integrating this equation indicates that the amount time required for an organic vapor to reach equilibrium with a polymer sorbent is proportional to its thickness.

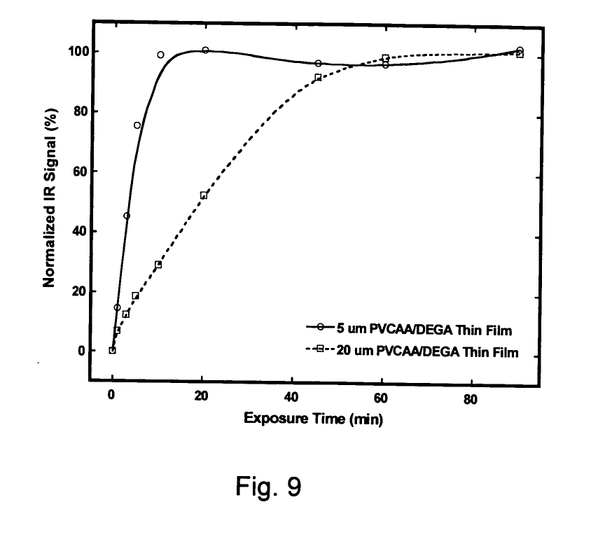

FIG. 9 shows the normalized IR absorbance versus exposure time for ca. 5 μm and 20 μm PVCAA/DEGA thin films exposed to 100 ppb DNB. Individual data points represent the percentage of the steady-state response, and the lines represent smooth curve fits. The T₉₀ response times for these data were 8 min for the 5 μm thin film and 45 min for the 20 μm thin film. As expected from Fick's first law of diffusion, these data clearly demonstrate that the response time to a specific analyte can be significantly increased by decreasing the thickness of the polymer sorbent. It will be appreciated that the layer thickness that provides a given response time may vary from polymer to polymer and may vary dependent upon the type an form of substrate employed as well as the specific sensor configuration. However, it will further be appreciated that layer thickness can be readily varied and the effect of this variation on sensor performance can be readily assessed without resort to undue experimentation.

### Example 2

### Metal Oxide Sorbent IR Sensors

Film Preparation:

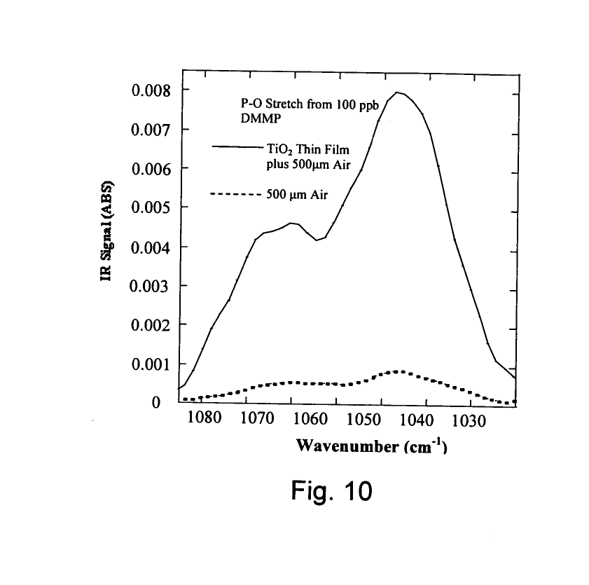

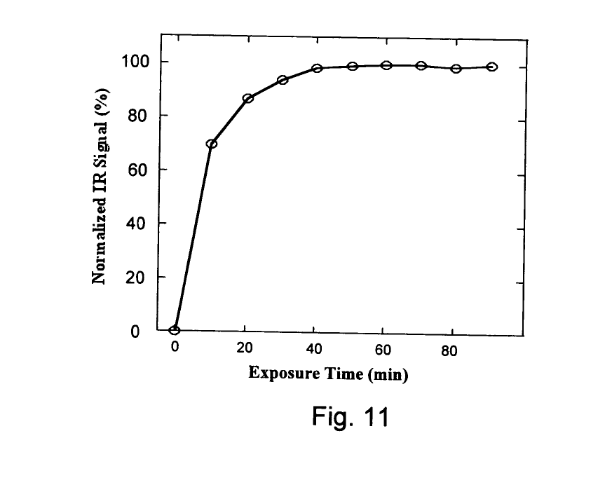

To prepare a film, a metal oxide was suspended in alcohol. For example, a suspension of 0.1 g TiO₂ (anatase, Alfa Aesar, 99.9%) in 2 mL isopropanol was prepared. The suspension was sonicated for 5 minutes to ensure a through dispersion of the metal oxide (e.g., TiO₂) in the solvent. A portion of the suspension was collected with a pipette, applied to the surface of an IR transparent substrate (a KBr disc), and allowed to evaporate. The thickness of this film was determined to be 25 μm based on a cross section examined by scanning electron microscopy (SEM) although various thicknesses can be achieved (0.1-100 microns) by varying the concentration of metal oxide in the suspension or altering the deposition method. A 0.025 g TiO₂ in 2 mL isopropanol suspension was used to form a ca. 6 micron thick sorbent layer to detect 100 ppb DMMP. FIG. 10 shows IR absorbance (the P—O stretch) of DMMP adsorbed into the anatase TiO₂ film contacted with 100 ppb DMMP in air. FIG. 11 shows normalized IR absorbance versus exposure time for the same film exposed to 100 ppb DMMP in air.

Furthermore, we have shown that other oxide films demonstrate the ability to concentrate low (100 ppb to 1 ppm) levels of DMMP in such a way that it may be detected with an infrared spectrometer. These included ZnO (NanoScale >99%), CeO₂ (Aldrich, 99.9%), and amorphous TiO₂ (NanoScale, >99.999%). Similar thickness sorbent layers of TiO₂ (anatase), TiO₂ (amorphous), ZnO and CeO₂ exhibited varying response levels on exposure to 100 ppb of DMMP with amorphous TiO₂ exhibiting the highest response. The other materials tested exhibited responses normailized to amorphous TiO₂ as follows: TiO₂ (anatase) 21%, ZnO 63% and CeO₂ 18%. In addition to these materials, many other oxides can be employed as the sorbent layer. These may include, but are not limited to, the following: SnO₂, Fe₂O₃, Al₂O₃, SiO₂, Ga₂O₃, La₂O₃, Nb₂O₅, PbO₂, MgO, ZrO₂, WO₃, V₂O₃, Cr₂O₃, NiO, CuO, Y₂O₃, SrO, CoO or combinations thereof.

Metal Oxide Dopants:

Oxide powders can be doped with metals to further enhance their adsorptive properties. Metal dopants can modify the chemical reactivity of the oxide surface either through electronic interactions with the substrate or through the production of new metallic binding sites.⁸ Also, metallic dopants have been shown to reduce sensor response times. Dopants can be added to oxide powders through processes such as sputtering or wet-chemical methods (coprecipitation, deposition-precipitation, etc.). Exemplary dopants include, but are not limited to, the following metals: Pt, Pd, Au, Cu, Ru, Ni, Ag, Fe, Cr, Os and mixtures thereof.

Metal Oxide Stoichiometry and Crystal Structure:

The stoichiometry of the metal oxide can be altered to improve sensing properties. Oxides with varied stoichiometries can be obtained from commercial suppliers or by treating a particular metal oxide in an appropriate oxidizing or reducing environment.

As an example, several oxides of titanium metal exist including TiO, TiO₂, Ti₂O₃, Ti₃O₅, and Ti₄O₇. The unique adsorption characteristics of each oxide can be particularly useful due to the presence of stronger or more selective binding sites. Furthermore, the crystal structure can be selected to facilitate the binding of VOCs. TiO₂, for example, is found in the anatase, rutile, or brookite crystallographic forms or it can be amorphous. A particular structure or form of metal oxide can exhibit improved binding of a VOC of interest. For example, a thin film composed of amorphous TiO₂ (evaporated from a 0.025 g TiO₂/2 mL isopropanol suspension) displayed a 5 fold increase in response to 100 ppb DMMP compared with an anatase TiO₂ film (evaporated with the same w/v ratio).

Alternative Metal Oxide Film Preparation:

A metal oxide sorbent material can be integrated into the detection package in numerous ways. The oxide can be pressed as a self supporting pellet with thicknesses ranging from 1 mm to 10 mm. Multiple thinner discs or pellets are preferred to fewer thicker discs or pellets because the use of thinner films or layers of the sorbent facilitates gas diffusion. Additionally, the oxide can be cast on a substrate that transmits infrared light such as KBr, ZnSe, AgBr, AgCl, CdTe, or Ge. Casting can be performed either through common thick film deposition techniques (as described previously), or films could be screenprinted, spray coated, e.g., with an airbrush, or spin coated. Preferred casting techniques control the thickness of the material and provide a uniform thickness of the oxide layer across the support. Metal oxide film thicknesses can range from 0.1 to 100 microns, but less than 20 microns is preferred because thinner layers are expected to facilitate gas diffusion and decrease response time. In addition, the oxide can also be pressed into a porous mesh or grid that has a sufficiently open structure to allow transmission of infrared light of wavelength to allow detection of an analyte of interest.

Metal Oxide Particle Size:

The particle size of the oxide employed can be varied either by purchasing commercial materials of varied particle sizes or by sintering the powders at high temperatures (≧400° C.). Particle sizes can range from 3 nm to 20 μm although the preferred size is less than 1 μm. Smaller particle sizes are beneficial for sensing applications because they provide a greater surface area for adsorption and scatter less infrared radiation than larger particles. Based on estimates and on the manufacturer's literature, the exemplary powders employed in these examples have particle size as listed:

TiO₂ (anatase): 200 nm

TiO₂ (amorphous): bimodal distribution of particles centered at 100 nm and 1 μm

ZnO: 2 μm

CeO₂: 5 μm

Metal Oxide Thermal Conditioning and Pretreatment Cycles to Ensure Reproducibility:

Several reports in the literature describe the formation of stable VOC species on metal oxide surfaces that lead to irreproducible sensor measurements.^{5,7} The application of high temperatures (>400° C. up to about 700° C.) can be used to rapidly clean the oxide surface after before and/or after sensing measurements, to remove contaminants or VOCs (after sensing exposures), and to regenerate an active surface for future adsorption. In this way, a high temperature treatment allows for more rapid sensor recovery times, as it would facilitate VOC decomposition/desorption and oxygen adsorption. Appropriate heating of the metal oxide surface can be accomplished by means of a controlled resistive heating element. For example, the oxide powder can be pressed into a tungsten grid that can be heated, or a heating element can be formed to encircle an oxide film cast on an infrared transparent window. Metal oxides are particularly resistant to thermal treatment and maintain a stable structure even after vigorous temperature cycling.

Another method to ensure sensor reproducibility is to pretreat the oxide film prior to sensing with the VOC of interest followed by a purge cycle using preferably air (or nitrogen or an inert gas). A range of pretreatment concentrations can be employed, for example the oxide film can be pretreated by exposure to concentrations of the analyte of interest ranging from 1 ppm to 100 ppm for a time that provides the desired reproducibility particularly from about 10 minutes to 1 hour. Irreversibly bound adsorbates would adhere during this process, and can be removed from subsequent analysis using background subtraction techniques. By doing this, the observed response and recovery times of the sensor can be improved.

Metal Oxide Incorporation with Polymer Films:

Several methods exist for integrating the metal oxide materials with the polymer film technology. The oxides can be blended with the polymers through mechanical mixing or by dissolving the polymer in a suspension containing the oxide powder. The blend is then cast as one or more films that are incorporated into the sensing device. Additionally, the polymers and oxides could be used as separate films placed in a series (along the optical path through the sensor) within the same sensing device. Also, the polymer (or the oxide) can be used without further modifications or combinations of other materials. These techniques can extend the dynamic range of the sensor, increasing the sensitivity, or improving the response time depending on the nature of the VOC to be analyzed.

### REFERENCES

1. R. C. Hughes, A. J. Ricco, M. A. Butler, and S. J. Martin, “Chemical Sensors”, Science, 254, p. 74, 1991.
2. J. Janata, Principles of Chemical Sensors, Plenum Press, New York, 1989.
3. M. J. Madou and S. R. Morrison, Chemical Sensing with Solid State Devices, Academic Press, New York, 1989.
4. A. J. Ricco, R. M. Crooks, and J. Janata, “Chemical Sensors: A Perspective of the Present and Past”, Interface, 7, p. 18., 1998, and references therein.
5. Penza, M., Tagliente, M. A., Mirenghi, L., Gerardi, C., Martucci, C., Cassano, G. “Tungsten trioxide (WO3) sputtered thin films for a NOx gas sensor” Sens. Actuators B 50 9-18 (1998).
6. Yamazaki, T., Shimazaki, T., Tereyama, K., Nakatani, N., Mohamed, G. A. “Gas sensing property of SnO2 sputtered films deposited under different conditions” J. Mater. Sci. Lett. 17 891-894 (1998).
7. Li, M., Chen, Y. “An investigation of response time of TiO2 thin-film oxygen sensors” Sens. Actuators B 32 83-85 (1996).
8. Savage, N. O., Akbar, S. A., Dutta, P. K. “Titanium dioxide based high temperature carbon monoxide selective sensors” Sens. Actuators B 72 239-248 (2001).
9. Kim, C. S., Lad, R. J., Tripp, C. P., “Interaction of organophosphorous compounds with TiO₂ and WO₃ surfaces probed by vibrational spectroscopy” Sens. Actuators B 76 442-448 (2001).
10. Tesfai, T. M., Sheinker, V. N., Mitchell, M. B., “Decomposition of dimethyl methylphosphonate (DMMP) on alumina-supported iron oxide” J. Phys. Chem. B 102 7299-7302 (1998).
11. Rusu, C. N., Yates, J. T., “Adsorption and decomposition of dimethyl methylphosphonate on TiO₂” J. Phys. Chem. B 104 12292-12298 (2000).
12. M. B. Mitchell, V. N. Sheinker, and E. A. Mintz, “Adsorption and Decomposition of Dimethyl Methylphosphonate (DMMP) on Metal Oxides,” J. Phys. Chem., 1997, 101, 11192.
13. Vlachos, D. S., Papadopoulos, C. A., Avaritsiotis, J. N. “Characterization of the catalyst-semiconductor interaction mechanism in metal-oxide gas sensors” Sens. Actuators B 44 458-461 (1997).
14. Mawhinney, D. B., Rossin, J. A., Gerhart, K. Yates, J. T., Jr. “Adsorption Studies by Transmission IR Spectroscopy: A New Method for Opaque Materials” Langmuir 15:4617-4621 (1999).
15. Basu, P., Ballinger, T. H., Yates, J. T., Jr. Rev. Sci. Instrum. 59:1321 (1988).
16. Ballinger, T. H., Wong, J. C. S., Yates, J. T., Jr. Langmuir 8:1676 (1992).
17. Tripp, C. P., Hair, M. L. “Reaction of Chloromethylsilanes with Silica; A Low-Frequency Infrared Study” Langmuir 7:923-927.
18. Morrow, B. A., Tripp, C. P., McFarlane, R. A. “Infrared spectra of adsorbed molecules on thin silica films” J. Chem. Soc., Chem. Commun. (1984) (19)1292.
19. Kanan, S. M., Tripp, C. P. “An Infrared Study of Adsorbed Organophosphonates on Silica: A Prefiltering Strategy for Detection of Nerve Agents on Metal Oxide Sensors” Langmuir 17:2213-2218 (2001).
20. J. D. Ingle, Jr. and S. R. Crouch, Spectrochemical Analysis, Prentice-Hall, New Jersey, 1989.
21. R. A. McGill, M. H. Abraham, and J. W. Grate, “Choosing Polymer Coatings for Chemical Sensors”, Chemtech, 9, p. 27, 1994.
22. A. J. Ricco, “SAW Chemical Sensors: An Expanding Role with Global Impact”, Interface, 3, p. 38, 1994.
23. E. T. Zellers, S. A. Batterman, M. Han, and S. J. Patrash, “Optimal Coating Selection for the Analysis of Organic Vapor Mixtures with Polymer-Coated Surface Acoustic Wave Sensor Arrays”, Anal. Chem., 67, p. 1092, 1995.
24. D. S. Ballantine, Jr., S. L. Rose, J. W. Grate, and H. Wohltjen, “Correlation of Surface Acoustic Wave Device Coating Responses with Solubility Properties and Chemical Structure Using Pattern Recognition”, Anal. Chem., 58, P. 3058, 1986.
25. J. W. Grate, S. L. Rose-Pehrsson, D. L. Venezky, M. Klusty, and H. Wohltjen, “Smart Sensor System for Trace Organophosphorus and Organosulfur Vapor Detection Employing a Temperature-Controlled Array of Surface Acoustic Wave Sensors, Automated Sample Preconcentration, and Pattern Recognition”, Anal. Chem., 65, p. 1868, 1993.
26. K. J. Albert, M. L. Myrick, S. B. Brown, D. L. James, F. P. Milanovich, and D. R. Walt, “Field-Deployable Sniffer for 2,4-Dinitrotoluene Detection”, Environ. Sci. Tech., 35, p. 3193, 2001.
27. S. M. Briglin, M. S. Freund, B. C. Sisk, and N. L. Lewis, “Array-Based Carbon Black-Polymer Composite Vapor Detectors for Detection of DNT in Environments Containing Complex Analyte Mixtures”, Proc. SPIE: Detection and Remediation Technologies for Mines and Minelike Targets VI, 4394, p. 912, 2001.
28. National Institute for Occupational Safety and Health publication entitled “Pocket Guide to Chemical Hazards”, (1999).
29. L. J. Kepley, R. M. Crooks, and A. J. Ricco, “Selective Surface Acoustic Wave-Based Organophosphonate Chemical Sensor Employing a Self-Assembled, Composite Monolayer: A New Paradigm for Sensor Design”, Anal. Chem., 64, p. 3191, 1992.
30. K. Hutchinson, S. Grossman, T. F. Jenkins, K. Sherbondy, and A. Mosquito, “Explosive-Related Chemical Concentrations in Surface Soils Over Buried Land Mines”, Proc. SPIE: Detection and Remediation Technologies for Mines and Minelike Targets VII, 4742, p. 544, 2002.
31. R. H. Perry, D. W. Green, and J. O. Maloney, Editors, Perry's Chemical Engineers' Handbook, 6^{th} edition, McGraw-Hill, Inc., New York, ch. 17, pp. 14-15, 1984.
32. R. A. McGill and Grate (1994) CHEMTECH 24(9):27-37

1. A chemical sensor for detection of one or more infrared active analytes in a gas in contact with the sensor which comprises:
an infrared source;
two or more sorbent layers each deposited on a surface of a substrate that is IR transparent or that is formed into an IR transparent element; and
an infrared detector;
wherein each sorbent layer is in contact with the gas; wherein each substrate is mounted in the sensor such that each surface upon which a sorbent layer is deposited is perpendicular to the direction of propagation of infrared light emitted from the infrared source and wherein infrared light emitted from the infrared source passes through the one or more sorbent polymer layers and is thereafter detected in the infrared detector.

2. (canceled)

3. The chemical sensor of claim 1 which comprises five or more sorbent layers.

4. The chemical sensor of claim 1 wherein the infrared source is a broad band IR emitter.

5. The chemical sensor of claim 1 wherein the infrared detector is a multispectral detector.

6. The chemical sensor of claim 1 wherein the sorbent comprises a polymer.

7. The chemical sensor of claim 6 wherein the sorbent polymer is a fluorinated epoxy.

8. The chemical sensor of claim 1 wherein the sorbent comprises a metal oxide.

9. The chemical sensor of claim 8 wherein the metal oxide is an amorphous metal oxide.

10. The chemical sensor of claim 9 wherein the metal oxide is TiO₂.

11.-15. (canceled)

16. The chemical sensor of claim 1 wherein the sorbent layers are each between 1 microns and 30 microns thick.

17. The chemical sensor of claim 1 wherein the sorbent layers are each between 0.1 microns and 20 microns thick.

18. The chemical sensor of claim 1 wherein the sorbent layers are each between 2 microns and 5 microns thick.

19. The chemical sensor of claim 1 configured to detect two or more target analytes.

20. The chemical sensor of claim 1 which is configured to monitor the ratio of IR absorption at two or more wavelengths one or which is a reference wavelength.

21. The chemical sensor of claim 1 which is configured to monitor the ratio of IR absorbance at one or more wavelengths characteristic of one or more target analytes to IR absorbance at a reference wavelength.

22. A sensor system which comprises one or more sensors of claim 1 for detection of one or more target analytes and an actuator responsive to the detection of the one or more target analytes wherein the actuator actuates an event in response to detection of the one or more analytes.

23. A sensor array which comprises one or more chemical sensors of claim 1.

24. A method for detecting one or more target analytes which comprises the step of introducing a chemical sensor of claim 1 into an environment which may contain the one or more target analytes are to be detected and measuring IR absorbance at one or more wavelengths characteristic of each of the one or more target analytes to be detected.

25. A method for determining the concentration of one or more target analytes in an environment which comprises the steps of introducing a sensor of claim 1 into the environment, measuring IR absorbance at one or more wavelengths characteristic of each of the one or more target analytes the concentration of which is to be determined and analyzing the IR absorbance measurements to determine the concentration of the one or more target analytes in the environment.

26. The chemical sensor of claim 1 comprising more than one substrate.

27. The chemical sensor of claim 1 further comprising a gas-permeable chamber wherein the infrared source, the infrared detector and each substrate are contained within the gas-permeable chamber.

28. The chemical sensor of claim 27 wherein the gas-permeable chamber is a sintered metal chamber.

29. The chemical sensor of claim 1 wherein the substrate is IR transparent.

30. The chemical sensor of claim 1 wherein the sorbent is a polymer selected from the group consisting of polyisobutylene and poly(vinylchloride-co-vinylacetate-co-vinylalcohol).

31. The method of claim 24 wherein the one or more target analytes are selected from one or more CWAs, organophosphorous compounds, ERCs, nitroaromatic compounds and chlorinated hydrocarbons.
